(19) United States
(12) Patent Application Publication
(10) Pub. No.: US 2009/0061380 A1
(43) Pub. Date: Mar. 5, 2009

(54) ORTHODONTIC APPLIANCE

(75) Inventors: Teruko Yamamoto, Okayama (JP); Hiroshi Kamioka, Kurashiki (JP); Taiji Adachi, Kyoto (JP); Shogo Fukushima, Moriguchi (JP); Takumi Sakimura, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC WORKS, LTD., Osaka (JP)

(21) Appl. No.: 11/721,086

(22) PCT Filed: Mar. 23, 2007
(86) PCT No.: PCT/JP07/56041

§ 371 Date: Jun. 7, 2007

(30) Foreign Application Priority Data
Mar. 28, 2006 (JP) 2006-089439
Mar. 28, 2006 (JP) 2006-089475
Nov. 27, 2006 (JP) 2006-317991

(51) Int. Cl. A61C 7/10

(52) U.S. Cl. 433/24; 433/18

(57) ABSTRACT

An orthodontic appliance capable of remarkably shortening a period of treatment and reducing burdens on patients is provided with braces to be mounted on a specified tooth included in teeth, a magnetic field generator and a magnetic element to be attached to the teeth. The magnetic element vibrates in response to a magnetic field generated by the magnetic field generator and applies the vibration thereof to the tooth on which the braces are mounted.

### TECHNICAL FIELD

The present invention relates to an orthodontic appliance.

### BACKGROUND ART

An orthodontic appliance equipped with an orthodontic wire to be mounted on teeth has been conventionally known. An elastic restoring force of the orthodontic wire acts as a constant static load on the teeth to correct teeth malalignment or crossbite. In other words, the orthodontic appliance is based on the principle of aligning the teeth by gradually deforming an alveolar bone supporting the teeth in the gum (bone remodeling) through the application of a constant force to the teeth.

However, the teeth alignment using the orthodontic wire takes a very long time (fastest six months, normally several years) until an orthodontic treatment is finished. This becomes a large burden on patients. Further, since this dental alignment is accompanied by pains, many patients do not wish such a treatment.

In order to shorten a period of such an orthodontic treatment, technology of giving a vibration force to the teeth has been studied. For example, a study result to the effect that if a sample A in which a constant force was applied to the teeth and a sample B in which a vibration force was applied to the teeth are compared, the sample B to which the vibration force was applied is more effective in shortening the period as shown in FIG. 17A is disclosed in non-Patent Literature 1.

Similarly, a study result to the effect that if a sample C in which a constant force was applied to the teeth and a sample D in which a constant force and a vibration force were applied to the teeth are compared, the sample D to which the constant force and vibration force were applied is more effective in shortening the period as shown in FIG. 17B is disclosed in non-Patent Literature 2.

According to these studies, the application of the vibration force to the teeth remarkably shortens the period of orthodontic treatment to about ½ to ⅓ as compared to conventional technologies. Further, it is sufficient to apply a vibration force only for 1.5 hours a day according to the former literature and only for 2 minutes at a time and once every two weeks according to the latter literature.

It can be understood from these studies that the teeth alignment by applying a vibration force as well as a constant force to the teeth is more effective in remarkably shortening the period of orthodontic treatment than the teeth alignment only by applying a constant force to the teeth using an orthodontic wire or the like.

### [Non-Patent Literature 1] Shimizu: “Journal of Japan Orthodontic Society” 45, pp. 56-72, 1986

### [Non-Patent Literature 2] Ohmae et al.: “Journal of Japan Orthodontic Society” 60(4), p. 201, 2001

### [Patent Literature 1] Japanese Unexamined Patent Publication No. 2002-102255

### [Patent Literature 2] Japanese Unexamined Patent Publication No. 2004-201895

### SUMMARY OF THE INVENTION

An object of the present invention is to provide an orthodontic appliance which can remarkably shorten a treatment period and reducing burdens on patients utilizing the study results described above.

In order to accomplish the above object, the present invention is directed to an orthodontic appliance for aligning a teeth, comprising braces to be mounted on a specified tooth included in the teeth to align the teeth; a magnetic field generator; and a magnetic element to be attached to the teeth so as to vibrate in response to a magnetic field generated by the magnetic field generator and apply the vibration to the tooth on which the orthodontic appliance is mounted.

In this appliance, the magnetic field generated by the magnetic field generator causes the magnetic element to vibrate, and the magnetic element applies the vibration thereof to the tooth on which the braces are mounted. This vibration promotes an orthodontic effect by the braces and shortening a period of orthodontic treatment. Since this appliance does not require wiring for power supply and the like, burdens on patients can be reduced.

### BRIEF DESCRIPTION OF THE DRAWINGS

FIG. 1 is an entire construction diagram of an orthodontic appliance according to a first embodiment of the invention.

FIG. 2 is a perspective view of the teeth of the lower dental arch of a user shown in FIG. 1.

FIG. 3 is a perspective view showing a state where a dental mouthpiece shown in FIG. 1 is mounted on the teeth shown in FIG. 2.

FIG. 4 is an exploded perspective view showing the dental mouthpiece when viewed from topside.

FIG. 5 is an exploded perspective view showing the dental mouthpiece from underside.

FIG. 6 is a block diagram showing the construction of an alternating current signal generating unit of the orthodontic appliance.

FIG. 7A is a diagram showing the action of a magnetic field generated by a coil on a permanent magnet in the orthodontic appliance, and FIG. 7B is a graph showing a change of a magnetic field generated by the coil with time.

FIG. 8 is a diagram showing coils of an orthodontic appliance according to a second embodiment of the invention.

FIG. 9 is a block diagram showing the construction of an alternating current signal generating unit of the orthodontic appliance according to the second embodiment of the invention.

FIG. 10 is a diagram showing an operation screen displayed on a display of a controller of the alternating current signal generating unit and used to set an alternating current signal.

FIG. 11 is a perspective view showing Helmholtz coils as an example of the coil.

FIG. 12 is a perspective view showing an example in which the coils are arranged at the opposite side walls of a pillow (headrest).

FIG. 13 is a perspective view showing coils of an orthodontic appliance according to a third embodiment of the invention.

FIG. 14 is a block diagram showing the construction of an alternating current signal generating unit of the orthodontic appliance according to the third embodiment of the invention.

FIG. 15 is a perspective view showing teeth of a lower dental arch having braces of an orthodontic appliance according to a fourth embodiment of the invention mounted.

FIG. 16 is a perspective view showing another example of the braces of the orthodontic appliance according to the fourth embodiment of the invention.

FIGS. 17A and 17B are graphs respectively showing an effect of shortening a period of orthodontic treatment.

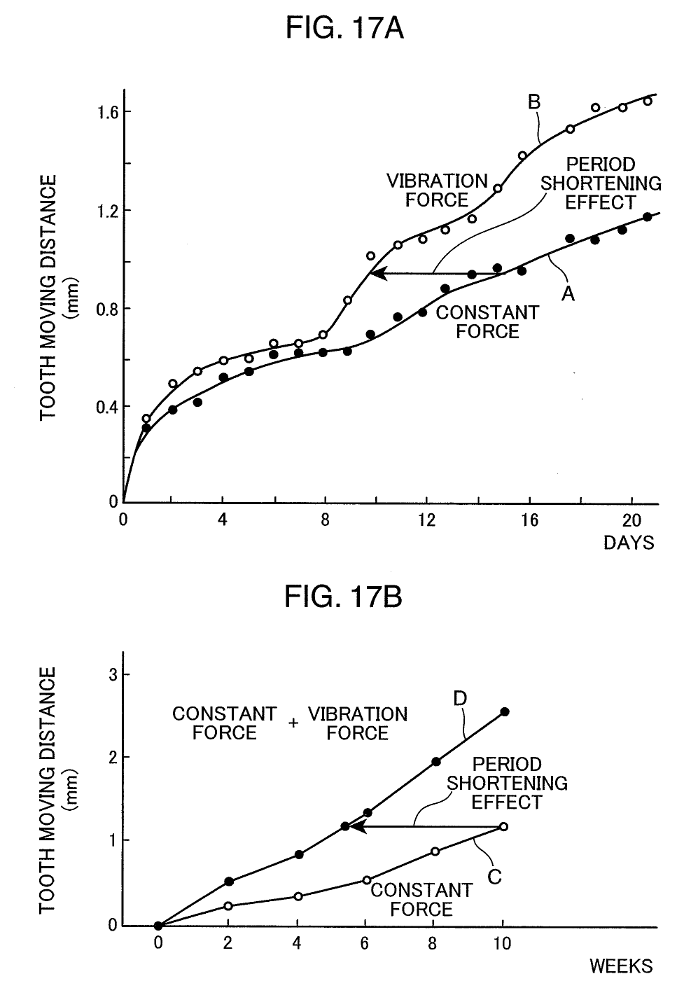

FIG. 18 is a perspective view showing one example of a dental mouthpiece producing apparatus according to the invention.

FIG. 19 is a system diagram showing a first example of a dental mouthpiece producing method of the invention using the producing apparatus shown in FIG. 18.

FIG. 20 is a diagram showing a second example of the dental mouthpiece producing method of the invention using the producing apparatus shown in FIG. 18.

FIGS. 21A and 21B are diagrams showing the process of casting a dental mouthpiece using an EVA sheet.

FIG. 22 is a perspective view showing a state where a dental mouthpiece according to a fifth embodiment of the invention is mounted on teeth.

FIG. 23 is a perspective view showing a state where a dental mouthpiece according to a sixth embodiment of the invention is mounted on teeth.

FIG. 24 is a perspective view showing a state where a dental mouthpiece according to a seventh embodiment of the invention is mounted on teeth.

FIG. 25 is a perspective view showing a state where a dental mouthpiece according to an eighth embodiment of the invention is mounted on teeth.

FIG. 26 is a perspective view showing a state where a dental mouthpiece according to a ninth embodiment of the invention is mounted on teeth.

FIG. 27 is a perspective view showing a state where a dental mouthpiece according to a tenth embodiment of the invention is mounted on teeth.

FIG. 28 is a perspective view showing a state where a dental mouthpiece according to an eleventh embodiment of the invention is mounted on teeth.

FIG. 29 is a perspective view showing a state where a dental mouthpiece according to a twelfth embodiment of the invention is mounted on teeth.

FIG. 30 is a section along the line 30-30 of FIG. 29.

FIG. 31 is an exploded perspective view showing the dental mouthpiece according to the twelfth embodiment of the invention when viewed from topside.

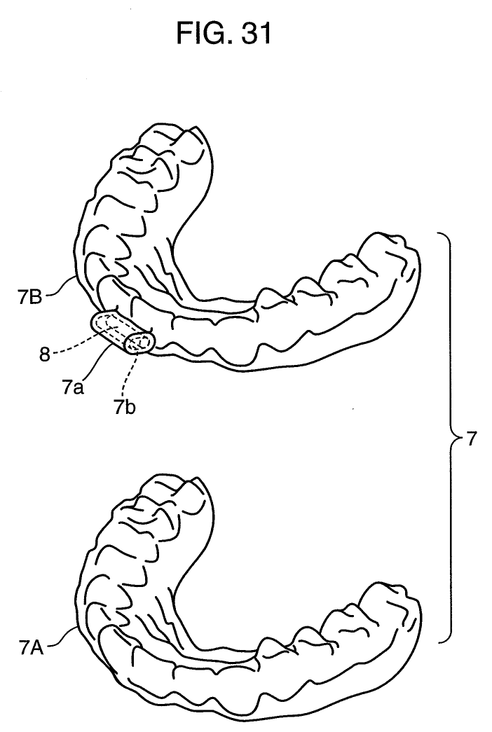

FIG. 32 is a graph showing an experiment result of the inventors of the invention.

FIG. 33 is a perspective view of an example of a dental mouthpiece similar to the dental mouthpiece according to the twelfth embodiment of the invention, but adopting a different orthodontic method.

FIG. 34 is a perspective view showing a state where a dental mouthpiece according to a thirteenth embodiment of the invention is mounted on a dental cast of a user.

FIG. 35 is a perspective view showing a state where a dental mouthpiece according to a fourteenth embodiment of the invention is mounted on the dental cast of the user.

FIG. 36 is a perspective view showing a state where a dental mouthpiece according to a fifteenth embodiment of the invention is mounted on the dental cast of the user.

FIG. 37 is a diagram showing a method for producing a dental mouthpiece having an inner surface form in conformity with a user's dental cast having braces mounted thereon.

### BEST MODES FOR CARRYING OUT THE INVENTION

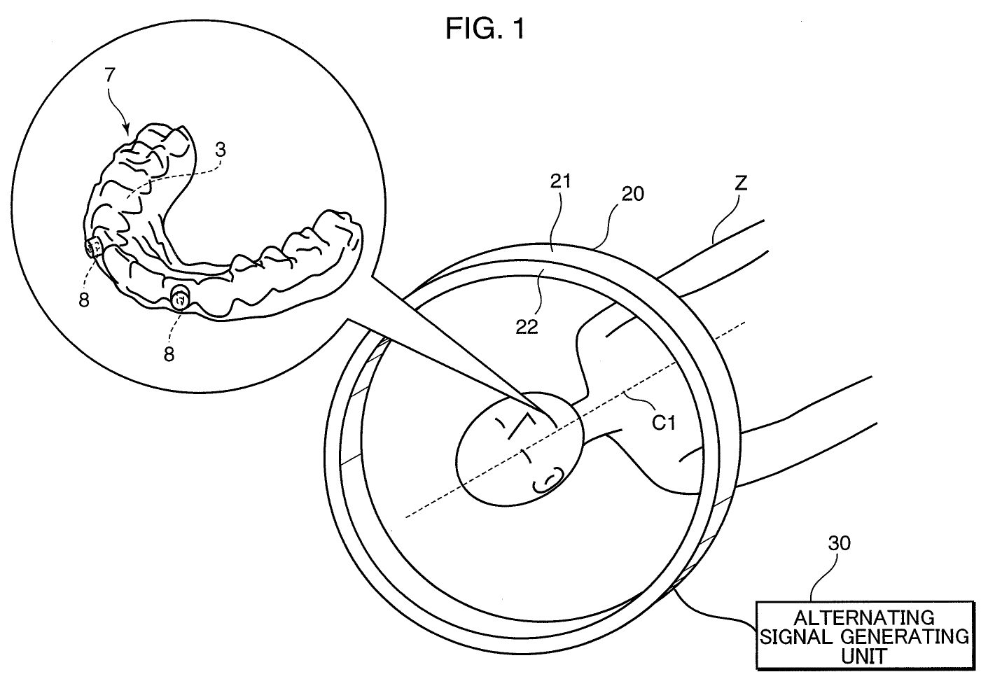

FIG. 1 shows the entire construction of an orthodontic appliance according to a first embodiment of the present invention. This orthodontic appliance includes a dental mouthpiece 7 to be mounted on the teeth of a user (patient) Z, a permanent magnet 8 as a magnetic element, a coil 20, and an alternating current signal generating unit 30 corresponding to a magnetic field generator. The coil 20 generates an alternating current magnetic field for vibrating the permanent magnet 8. The permanent magnet 8 vibrates in response to the alternating current magnetic field, and applies this vibration to teeth 3 via the dental mouthpiece 7. Iron-containing ferrite magnets, neodymium-iron-boron and samarium-cobalt rare earth magnets having a very large maximum energy product (BH)max[J/m³] are preferably used as this permanent magnet 8.

The coil 20 is a round coil in this embodiment and arranged such that a central axis C1 of this round coil extends in horizontal direction. More specifically, the coil 20 includes a tubular bobbin 22 and a wire 21 wound around this bobbin 22 to have a specified winding number, wherein the inner diameter of the bobbin 22 is set larger than a maximum outer diameter of the cross section of the face of the user Z.

The alternating current signal generating unit 30 is electrically connected with the wire 21 of the coil 20, and applies an alternating current signal for generating the alternating current magnetic field to the coil 20. This alternating current magnetic field vibrates the permanent magnet 8. More specifically, the alternating current signal generating unit 30 causes a magnetic field in the coil 20 to be generated by supplying an alternating current signal having a frequency of, e.g. 50 to 150 Hz to the coil 20. The winding number of the coil 20 and the amplitude of the alternating current signal generated by the alternating current signal generating unit 30 are set at such values that the effective value or amplitude of the magnetic field at the central axis C1 of the coil 20 is 0.15 mT to 0.18 mT, more preferably 0.16 mT to 0.17 mT. A synergic effect of the application of a magnetic field having a magnitude of 0.15 mT to 0.18 mT to the teeth 3 and the application of mechanical stimuli (vibration) to the teeth 3 by the permanent magnet 8 effectively shortens a treatment period. In other words, a bone formation promoting effect is known to be improved if a magnetic field of 0.15 mT to 0.18 mT is applied to the teeth. This is written in “Effect of a Pulsing Electromagnetic Field on Demineralized Bone-matrix-induced Bone Formation” by T. Takano-Yamamoto, et al., J. Dent. Res., Vol. 71, No. 12, pp. 1920-1925, 1992.

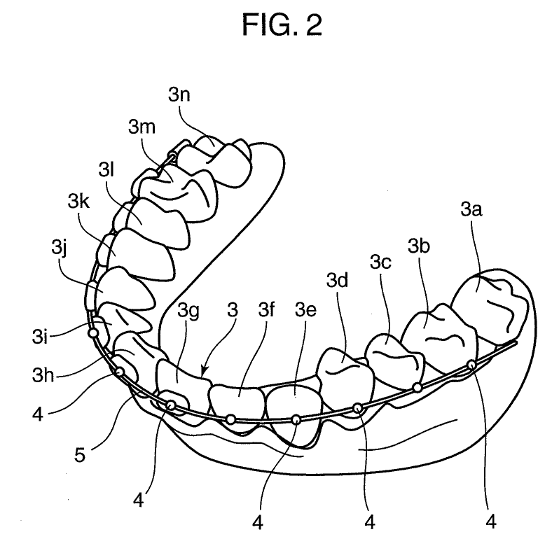

The above orthodontic appliance is used in the following manner. The user Z places his face inside the coil 20 while wearing braces (see FIG. 2) to be described in detail later and the dental mouthpiece 7, and locates his mouth in the center of the coil 20 on the central axis C1 of the coil 20. On the other hand, the coil 20 generates such an alternating current magnetic field as to vibrate the permanent magnet 8 attached to the dental mouthpiece 7, and the permanent magnet 8 vibrated by this alternating current magnetic field transmits this vibration to the teeth 3 via the dental mouthpiece 7 to vibrate the teeth 3. In other words, the vibration of the permanent magnet 8 is applied to the teeth 3 in addition to an aligning force by the braces. This vibration promotes an orthodontic function by the braces and remarkably shortens a period of orthodontic treatment.

The posture of the user Z during the treatment can be arbitrarily set. For example, the user Z is in a laid-down posture in FIG. 1. In the case of adopting this posture, a bed on which the user Z lies down may be installed. The height of this bed is preferably set such that the mouth of the user Z is located on the central axis C1 of the coil 20. The coil 20 may be arranged such that the central axis C1 of the coil 20 extends in vertical direction. In such a case, the user Z places his face inside the coil 20 in a standing posture. Thus, an adjusting mechanism (not shown) for enabling the height adjustment of the coil 20 in conformity with the height of the user Z may be attached to the coil 20. Further, in the case of arranging the coil 20 such that the central axis C1 of the coil 20 extends in vertical direction, the user Z can receive a treatment in such a seating posture in a chair. This treatment in the seating posture can further reduce burdens on the user Z.

FIG. 2 shows one example of the braces. These braces are mounted on the teeth 3 of the lower dental arch of the user Z and includes an orthodontic wire (arched orthodontic wire) 5 to be arranged along the teeth 3 and a plurality of brackets 4 for locking the orthodontic wire 5 in position. The teeth 3 is comprised of a plurality of teeth 3a to 3n, and the respective brackets 4 are fixed to the buccal surfaces of the teeth 3b to 3m of the teeth 3 excluding posterior teeth 3a, 3n, these brackets 4 fixing the orthodontic wire 5 to the teeth 3. The orthodontic wire 5 is mounted on the teeth 3 while being elastically deformed, and exhibits an effect of correcting malocclusion by applying a resulting elastic restoring force to the teeth 3 as a constant force (static load).

The braces according to the present invention are not limited to those comprised of the orthodontic wire 5 and the brackets 4, and any braces will do provided they can apply a suitable tooth aligning force to the teeth 3.

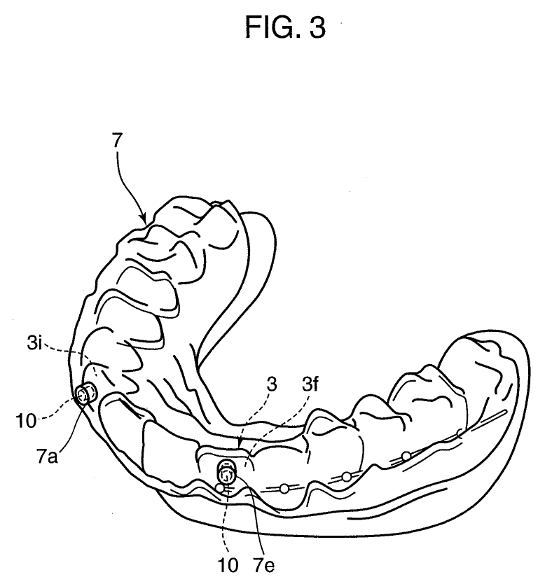

An exemplary construction of the dental mouthpiece 7 is described with reference to FIGS. 3 to 5. FIG. 3 shows a state where the dental mouthpiece 7 shown in FIG. 1 is mounted on the teeth 3 shown in FIG. 2. The dental mouthpiece 7 shown in FIG. 3 is so shaped as to be mountable on the entire teeth 3, and the permanent magnets 8 are mounted at parts of the dental mouthpiece 7 located at the outer sides of the second teeth 3f, 3i to right and left from the center. The permanent magnets 8 vibrate by the action of the alternating current magnetic field generated by the coil 20 and apply the resulting vibration to the teeth 3.

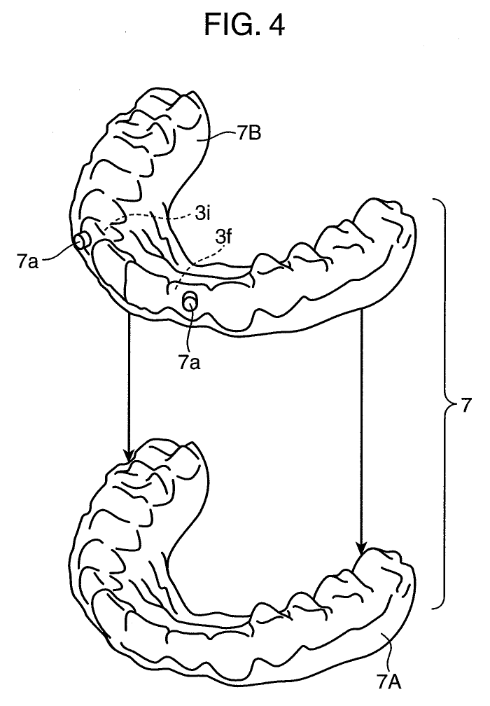

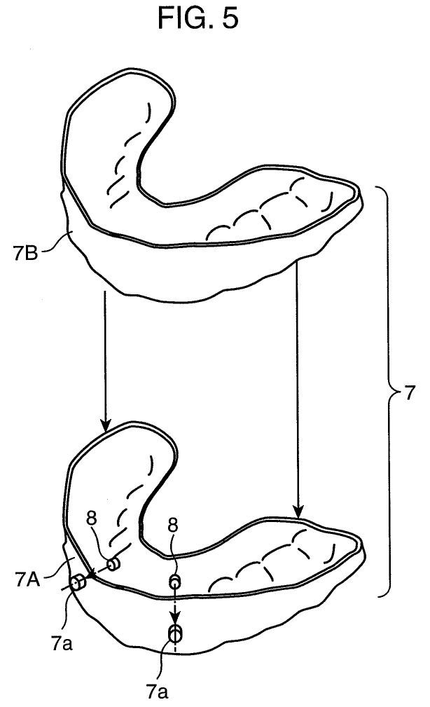

FIG. 4 is an exploded perspective view showing the dental mouthpiece 7 when viewed from topside, and FIG. 5 is an exploded perspective view showing the dental mouthpiece 7 from underside. The dental mouthpiece 7 has an inner and outer overlaid structure. Specifically, the dental mouthpiece 7 is comprised of an inner layer 7A to be directly mounted on the teeth 3 and an outer layer 7B mounted on the outer side of the inner layer 7A. The dental mouthpiece 7 is formed by placing these layers 7A, 7B inside out.

The material of the inner layer 7A and the outer layer 7B are not particularly limited, but preferably a material normally used for mouthpieces and having guaranteed hygienic safety. The use of, e.g. an EVA (ethylene vinyl acetate), which is a polymer material, a thermoplastic, a thermoplastic elastomer, a silicone rubber is preferable because it can suppress the side effects on teeth and gums or gingival tissues such as allergy. Particularly, an EVA sheet is preferable since it has high electrically insulating property and heat insulating property. If this EVA sheet is used for the inner layer 7A, the softness of the EVA sheet can alleviate the transmission of vibration from the permanent magnets 8 to the teeth 3i, 3f, thereby preventing damages near the teeth 3i, 3f resulting from the vibration.

As shown in FIG. 5, the outer layer 7B is formed with outward bulging projecting portions 7a, and the inner layer 7A is bonded to the outer layer 7B with the permanent magnets 8 placed inside the projecting portions 7a. In this way, the permanent magnets 8 are built in the dental mouthpiece 7. The outer layer 7B and the inner layer 7A are preferably joined and united with each other airtight, for example, by means of ultrasonic welding. The airtight state mentioned here means a state where the entrance of moisture between the two layers 7A, 7B is hindered (i.e. watertightness can be maintained). The joining of the outer layer 7B and the inner layer 7A bringing about such an airtight state hinders the entrance of moisture such as saliva and cleaning liquid into the inner sides of the two layers 7A, 7B (particularly inside the projecting portions 7a), thereby effectively protecting the permanent magnets 8 from the moisture.

The inner spaces of the projecting portions 7a are preferably larger than the outer shapes of the permanent magnets 8. The perfectly close contact of the inner surfaces of the projecting portions 7a and the inner surface of the inner layer 7A with the permanent magnets 8 might restrict the vibration of the permanent magnets 8. Therefore, the inner spaces of the projecting portions 7a are preferably dimensioned to such a degree as to permit the vibration of the permanent magnets 8. As a means of forming in a dental mouthpiece 7 a storage space larger than the size of the permanent magnet 8 in order to increase the load for imparting stimuli, for example, the permanent magnet 8 is stored in a capsule larger than the permanent magnet 8, and the capsule is placed in the mouthpiece 7.

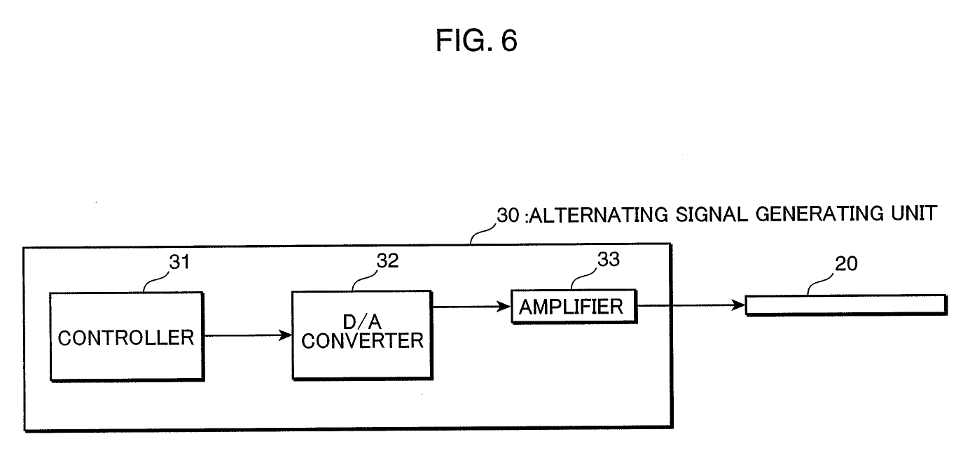

FIG. 6 is a block diagram showing an exemplary construction of the alternating current signal generating unit 30. This alternating current signal generating unit 30 includes a controller 31, a D/A converter 32 and an amplifier 33.

The controller 31 is constructed by a personal computer, generates a digital alternating current signal and outputs it to the D/A converter 32. The personal computer includes a display device such as a liquid crystal panel, an input device such as a mouse and a keyboard, a CPU, a ROM, a RAM, a hard disk, etc. The hard disk stores an alternating current signal generation program for generating a specified digital alternating current signal based on the amplitude, frequency and the like of an alternating current signal inputted using the input device. The CPU outputs the alternating current signal (signal having an amplitude and the like designated by a user) to the D/A converter 32 by the implementation of the alternating current signal generation program.

The D/A converter 32 is connected with the controller 31, for example, via a USB cable, and generates an analog alternating current signal by digital-to-analog converting the digital alternating current signal outputted from the controller 31 and inputs this signal to the amplifier 33. The amplifier 33 amplifies the analog alternating current signal inputted from the D/A converter 32 with a specified gain, and outputs the amplified signal to the coil 20.

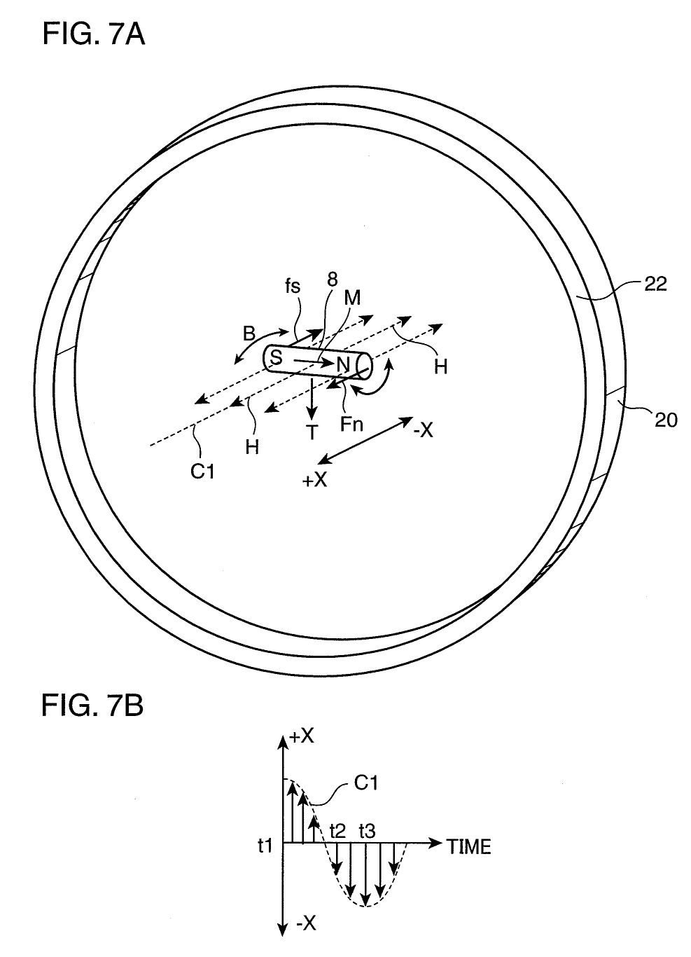

FIG. 7A is a diagram showing the action of a magnetic field H generated by the coil 20 on the permanent magnet 8, and FIG. 7B is a graph showing a change of the magnetic field with time. “+X” in FIG. 7A indicates a forward direction along the central axis C1 and “−X” indicates a direction opposite to (180° from) “+X”.

Since a current flows along the circumferential direction of the bobbin 22 in the coil 20, the magnetic field H is generated in a direction in parallel with the central axis C1 near the center of the coil 20. Since the current is an alternating current, the magnitude of the magnetic field H cyclically changes. Specifically, as shown in FIG. 7B, the magnetic field H oriented in +X direction at time t1 decreases along a sinusoidal curve toward time t2, and zeros at time t2. Thereafter, the magnetic field H increases in −X direction along the sinusoidal curve toward time t3 and decreases along the sinusoidal curve again after reaching a peak at time t3.

Accordingly, the vibration of the permanent magnet 8 is realized by arranging the permanent magnet 8 in such a posture that the direction of a magnetic moment M of the permanent magnet 8 is normal to the +X direction and −X direction. The permanent magnet 8 arranged in such a posture receives a vertically downward torque T having a magnitude proportional to the product of the magnetic field H and the magnetic moment M when the magnetic field H is oriented in +X direction and, conversely, receives a vertically upward torque T having a magnitude proportional to the product of the magnetic field H and the magnetic moment M when the magnetic field H is oriented in −X direction. The torque T whose direction cyclically changes causes the permanent magnet 8 to vibrate as shown by arrows B in FIG. 7A.

An increase in the frequency of the alternating current signal speeds up changes in the direction of the magnetic field, thereby increasing the vibration speed of the permanent magnet 8. Accordingly, an upper limit value of the frequency of the alternating current signal is restricted by the mass, shape and other conditions of the permanent magnet 8, but a control of the vibration speed of the permanent magnet 8 is enabled through the frequency adjustment within such a range of restriction. Since the intensity of the magnetic field H generated by the coil 20 is proportional to an effective value of the alternating current signal (alternating current) supplied to the coil 20, a control of the magnitude of the torque T is enabled through the adjustment of the effective value of the alternating current signal if the magnetic moment M of the permanent magnet 8 is constant.

Specifically, the speed and amplitude of the mechanical vibration of the permanent magnet 8 built in the dental mouthpiece 7 are controlled through the adjustment of the frequency and effective value of the alternating current signal supplied to the coil 20 arranged outside the dental mouthpiece 7. This enables mechanical stimuli (vibration) having characteristics suitable for teeth alignment to be applied to the teeth of the user Z wearing the dental mouthpiece 7.

As described above, in the orthodontic appliance according to the first embodiment, the coil 20 generates the magnetic field H to vibrate the permanent magnet 8 and this vibration is applied to the teeth on which the braces are mounted. Since this vibration promotes the orthodontic function by the braces and shortens the period of orthodontic treatment. Since the permanent magnet 8 vibrates by the action of the magnetic field H, it is not necessary to physically directly connect this permanent magnet 8 and the coil 20. This eliminates the need for wiring to feed power to the permanent magnet 8 as a vibrating element and further makes it unnecessary for the user Z to wear a magnetic field generator. Thus, a patient (user Z) can freely move without being annoyed by wiring and the like within the range of the magnetic field H generated by the coil 20, which reduces burdens on the patient.

The embedding of the permanent magnet 8 between the outer layer 7B and the inner layer 7A hinders the direct contact of the permanent magnet 8 with the user Z. This prevents the elution of a specific component from the permanent magnet 8 caused by the saliva of the user Z and the side effects of this component on the user Z.

Further, it makes the dental mouthpiece 7 water-washable to build the permanent magnet 8 in the dental mouthpiece 7. If the permanent magnet 8 contains iron, this permanent magnet 8 might be corroded by being exposed to moisture. The separation of the permanent magnet 8 from the outside by being built in the dental mouthpiece 7 enables the dental mouthpiece 7 to be washed with water, thereby facilitating the maintenance of the dental mouthpiece 7.

The dental mouthpiece according to the present invention is not limited to the one to be so mounted as to cover the entire teeth as shown in FIG. 3 and, for example, may be of such a size as to be mounted only on a specific part of the teeth including the tooth to be aligned or may be of such a size as to be mounted on the tooth to be aligned.

The dental mouthpiece 7 may be so shaped as to fulfill the orthodontic function itself. This eliminates the need for the exclusive braces including the orthodontic wire 5 and the like. Such a dental mouthpiece may have a shape in conformity with the teeth 3 to be aligned or may have a shape slightly different from the teeth before teeth alignment and in conformity with a targeted shape of the teeth 3 to be aligned. The latter shape enables an elastic force of the dental mouthpiece 7 to be utilized as an aligning force.

The number and arranged positions of the permanent magnets 8 are not restricted, either. Although the appliance in which the two permanent magnets 8 are arranged for the right and left teeth 3f, 3i is shown in FIG. 3, one, three or more permanent magnets 8 may be arranged. Further, the permanent magnets 8 may be mounted on the back side (tongue side) of the teeth 3 or may be so mounted on the top of the dental mouthpiece 7 as to be located at the crown portions of the teeth.

The structure of the dental mouthpiece 7 is not limited to the inner and outer overlaid structure. This dental mouthpiece 7 may be formed of a single layer.

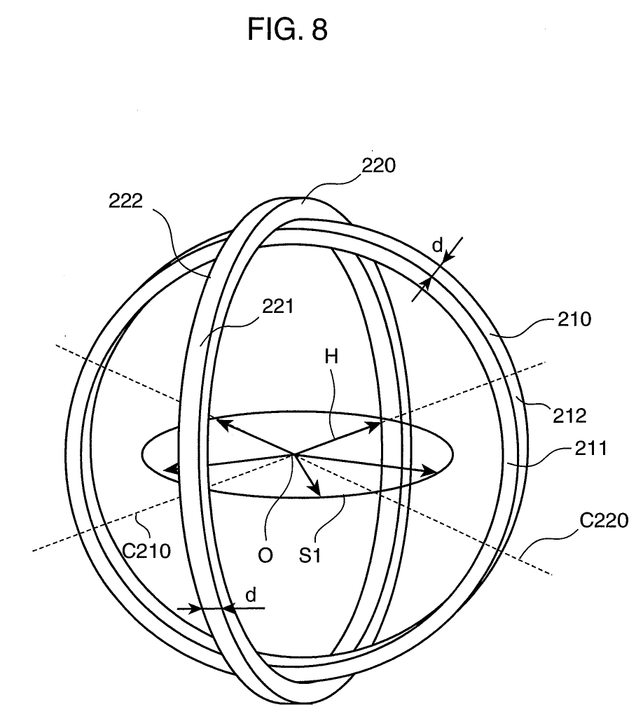

A second embodiment of the present invention is described with reference to FIGS. 8 to 10. Parts common to the orthodontic appliance according to this embodiment and the one according to the first embodiment are identified by the same reference numerals and not described.

The orthodontic appliance according to the second embodiment is provided with two round coils 210, 220 as shown in FIG. 8. The coil 210 includes a bobbin 211 and a wire 212 wound around this bobbin 211. The inner diameter of the bobbin 211 is substantially equal to that of the bobbin 22 according to the first embodiment. The coil 220 includes a bobbin 221 and a wire 222 wound around this bobbin 221, and the inner diameter of the bobbin 221 is set substantially equal to the outer diameter of the coil 210. Both bobbins 211, 221 have a common width d.

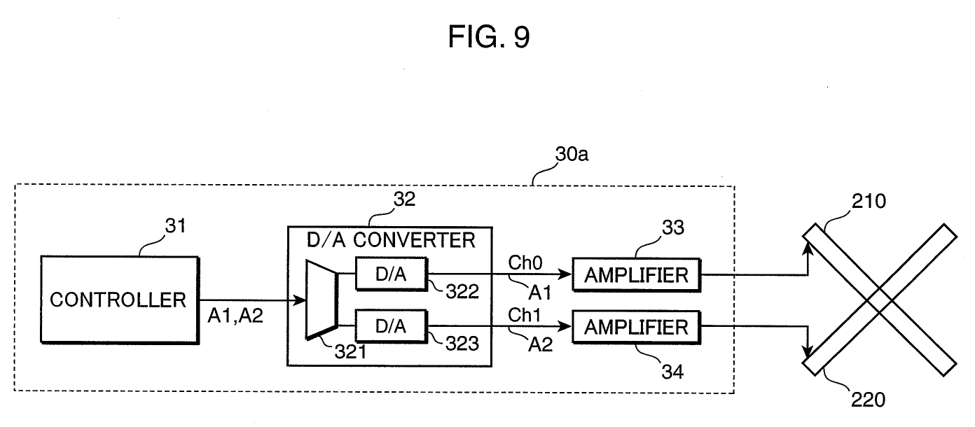

The orthodontic appliance according to the second embodiment is provided with an alternating current signal generating unit 30a having a construction as shown in FIG. 9. This alternating current signal generating unit 30a includes a controller 31 and a D/A converter 32 similar to the alternating current signal generating unit 30 according to the first embodiment, and further includes two amplifiers 33, 34 in correspondence with the two coils 210, 220.

The controller 31 generates a digital alternating current signal A1 corresponding to the coil 210 and a digital alternating current signal A2 corresponding to the coil 220, and inputs these signals A1, A2 to the D/A converter 32 while applying time division multiplex thereto.

The D/A converter 32 includes a multiplexer 321, a D/A converter 322 corresponding to a channel Ch0, and a D/A converter 323 corresponding to a channel Ch1. The multiplexer 321 outputs the digital alternating current signal A1 to the D/A converter 322 and outputs the digital alternating current signal A2 to the D/A converter 323 under the control of the controller 31. The D/A converter 322 analog-to-digital converts the digital alternating current signal A1 and the outputs the resulting signal to the amplifier 33 under the control of the controller 31. The D/A converter 323 analog-to-digital converts the digital alternating current signal A2 and the outputs the resulting signal to the amplifier 34 under the control of the controller 31.

The amplifiers 33, 34 output the alternating current signals A1, A2 to the respective coils 210, 220 after amplifying them with specified gains.

As shown in FIG. 8, both coils 210, 220 are arranged such that a central axis C21 of the coil 210 orthogonally crosses a central axis C220 of the mating coil 220 at a center O of the coil 210. Such an arrangement enables a magnetic field to be generated in an arbitrary direction in a horizontal plane S1 including the central axes C210, C220 by setting the amplitudes, phases and frequencies of the alternating current signals respectively supplied to the coils 210, 220 to suitable values.

For example, if the frequencies of the alternating current signals (alternating currents) A1, A2 respectively supplied to the coils 210, 220 are equal to each other and a phase difference of the two signals A1, A2 is 0, a magnetic field H that changes only along one direction as shown in FIG. 7B is generated. The magnetic field that is oriented along one direction and cyclically changes in magnitude is called an alternate magnetic field. This alternate magnetic field is a special example of an alternating current magnetic field.

If the frequencies of the alternating current signals (alternating currents) A1, A2 respectively supplied to the coils 210, 220 are equal to each other and a phase difference of the two signals A1, A2 is 90°, the direction of the generated magnetic field H rotates in the horizontal plane S1 as shown in FIG. 8. This rotating direction is determined based on which of the alternating current signals A1, A2 is more advanced in phase.

When an integral multiple relationship holds between the frequencies of the alternating current signals (alternating currents) A1, A2 respectively supplied to the coils 210, 220, the magnitude of the generated magnetic field H cyclically changes in addition of the rotation of the direction of the magnetic field H in the horizontal plane S1. Accordingly, the direction of the torque T applied to the permanent magnet 8 or the vibrating direction of the permanent magnet 8 can be adjusted by setting the direction of the magnetic moment M of the permanent magnet 8. The direction of the magnetic moment M can be adjusted by changing the orientation of the permanent magnet 8 in the dental mouthpiece 7 or changing the facing direction of the user.

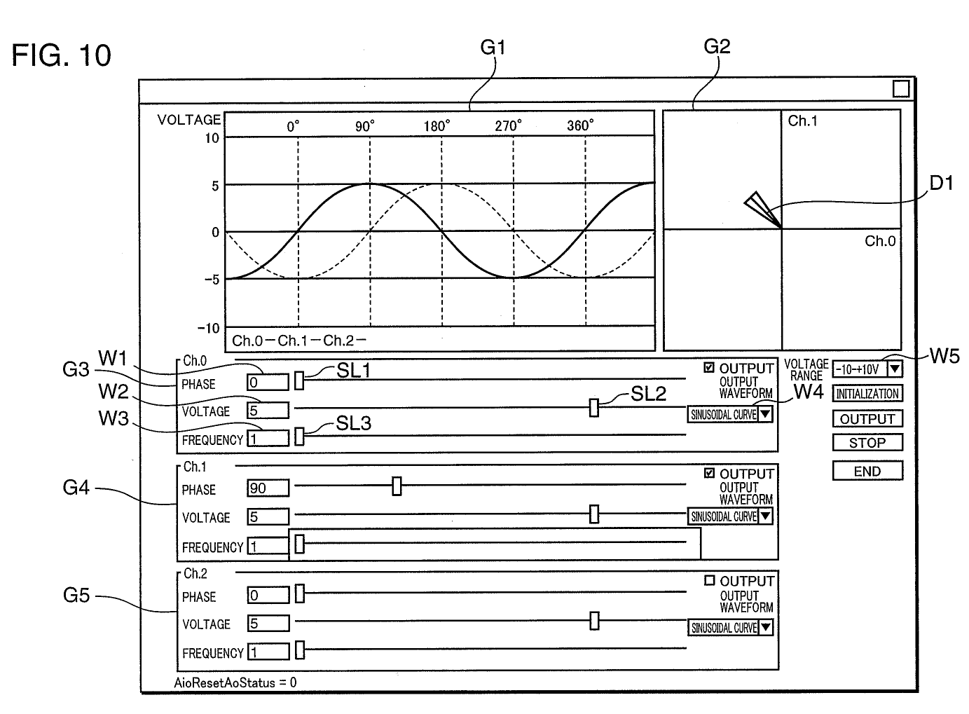

The controller 31 includes a display device, on which an operation screen used to set the alternating current signals A1, A2 is displayed. An example of the operation screen is shown in FIG. 10. The screen shown here includes two waveform display sections G1, G2 and three setting sections G3 to G5.

The setting sections G3 to G5 are each provided with columns used to set the phase, voltage and frequency. The phase, voltage and frequency of the alternating current signal A1 are set by operating the setting section G3, whereas the phase, voltage and frequency of the alternating current signal A2 are set by operating the setting section G4. In the case of using three coils as in a third embodiment to be described later, the phase, voltage and frequency of an alternating current signal A3 corresponding to the third coil are set by operating the setting section G5. These setting sections G3 to G5 have an identical construction. Accordingly, the following description is made, taking the setting section G3 as an example.

The setting section G3 includes three numeric display columns W1 to W3 displayed at its left part and three slide bars SL1 to SL3 displayed at the right sides of the respective numeric display columns W1 to W3. The numeric display columns W1 to W3 numerically display the phase, voltage (amplitude) and frequency set for the alternating current signal A1. The respective slide bars SL1 to SL3 can be dragged by a mouse, and numerical values corresponding to dragged amounts are displayed in the respective numeric display columns W1 to W3. For example, the numeric display column W1 displays “0” when the slide bar SL1 for the phase adjustment is located at the left end while displaying “360°” when the slide bar SL1 is located at the right end. Accordingly, an operator can set the phase of the alternating current signal A1 by dragging the slide bar SL1. Further, the phase, amplitude and frequency can be also set by directly entering numerical values in the numeric display columns W1 to W3.

An output waveform column W4 used to select the waveform of the alternating current signal A1 is displayed at the right side of each of the slide bars SL1 to SL3. A pull-down menu used to select a desired waveform out of a plurality of waveforms set beforehand is displayed in this output waveform column W4.

A voltage range column W5 used to set the amplitude scale of the alternating current signal is displayed at the right side of the setting sections G3 to G5. For example, if a voltage range is set to a range of −10 V to +10 V in this voltage range column W5, a numerical value within a range of 0 to 10 can be displayed in the numeric display column W2 and the amplitude of the alternating current signal A1 can be set within this range.

The waveform display section G1 displays a graph having vertical and horizontal axes respectively representing voltage and phase and displaying three alternating current signals set by the respective setting sections G3 to G5. Since the two coils 210, 220 are used in the second embodiment, FIG. 10 shows a state where the waveforms of the alternating current signals A1, A2 set in the setting sections G3, G4 are displayed. In the case of using three coils, the waveform of the alternating current signal A3 set for the third coil is also displayed in the waveform display section G1.

The controller 31 causes a composite of the alternating current signals A1 to A3 set in the setting sections G3 to G5 to be displayed in the waveform display section G2. The waveform display column G2 shows a composite waveform when viewed in a direction from right above the coils 210, 220, wherein the vertical axis thereof represents the channel Ch1, i.e. the coil 220 and the horizontal axis thereof represents the channel Ch0, i.e. the coil 210. For example, if the phase of the alternating current signal A2 is displaced by 90° from the phase of the alternating current signal A1 as shown in FIG. 10, a composite magnetic field of the magnetic field generated by the coil 210 and the one generated by the coil 220 rotates in counterclockwise direction in the horizontal plane S1, wherefore a fan-shaped area D1 representing the magnetic field H rotates counterclockwise in the waveform display column G2.

As described above, since the magnetic field generator of the orthodontic appliance according to the second embodiment includes the two coils 210, 220, an alternate magnetic field whose magnitude cyclically changes along one direction, a magnetic field whose direction rotates in the horizontal plane S1 or a magnetic field whose magnitude cyclically changes while the direction thereof rotates in the horizontal plane S1 can be generated. This enables the permanent magnet 8 to vibrate in a plurality of patterns.

The central axis C210 of the coil 210 and that C220 of the coil 220 may not necessarily be orthogonal to each other. For example, the two coils 210, 220 may be arranged such that the two central axes C210, C220 intersect at an angle other than 90° at the center O.

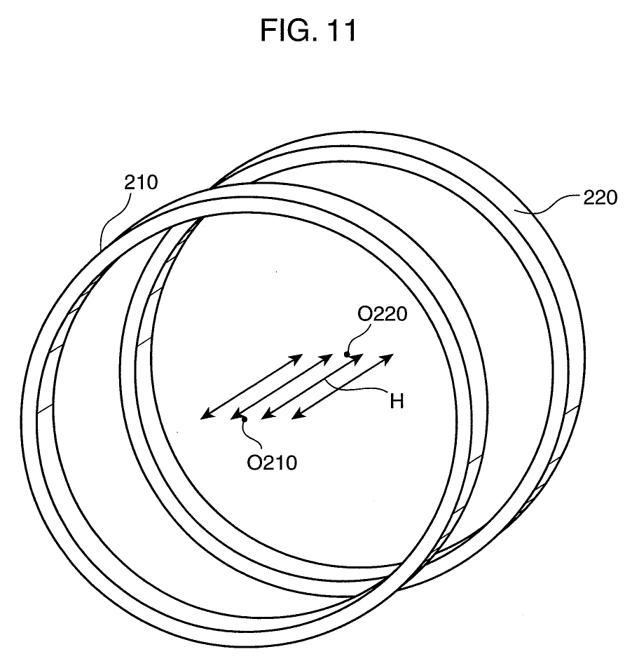

Further, the magnetic field generator according to the present invention may include Helmholtz coils. These Helmholtz coils are a plurality of round coils having an equal radius are arranged at coaxial positions at intervals equal to the common radius, for example, like coils 210, 220 shown in FIG. 11. In the Helmholtz coils, currents of the same magnitude are caused to flow in the same direction in the respective round coils, whereby an area near the center where the intensity of the magnetic field H is constant is extended and this extension of the area stabilizes the vibration of the permanent magnet 8. In other words, the magnetic field acting on the permanent magnet 8 can be kept constant even if the head of the user Z slightly moves. This improves robustness against a sudden head motion, thereby enabling a more uniform torque to be applied to the permanent magnet 8.

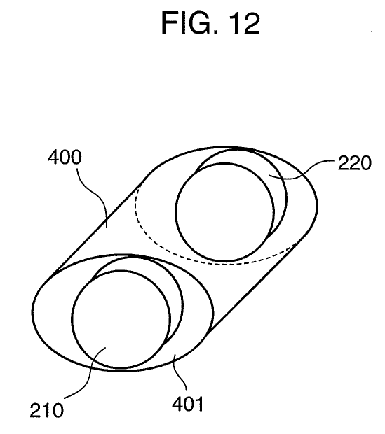

The coils 210, 220 may be arranged at opposite side walls 401, 402 of a pillow (headrest) 400 on which the head of the user Z is to be placed as shown in FIG. 12. In such a case as well, the two coils 210, 220 are preferably arranged at coaxial positions. The diameter of both coils 210, 220 are preferably about 100 mm. If the user Z lies down and places his head on the pillow 400 while wearing the dental mouthpiece 7, the alternating current magnetic field H generated by the coils 210, 220 causes the permanent magnet 8 to vibrate in the dental mouthpiece to apply this vibration to the teeth of the user Z. The use of such a pillow 400 reduces burdens on the user Z.

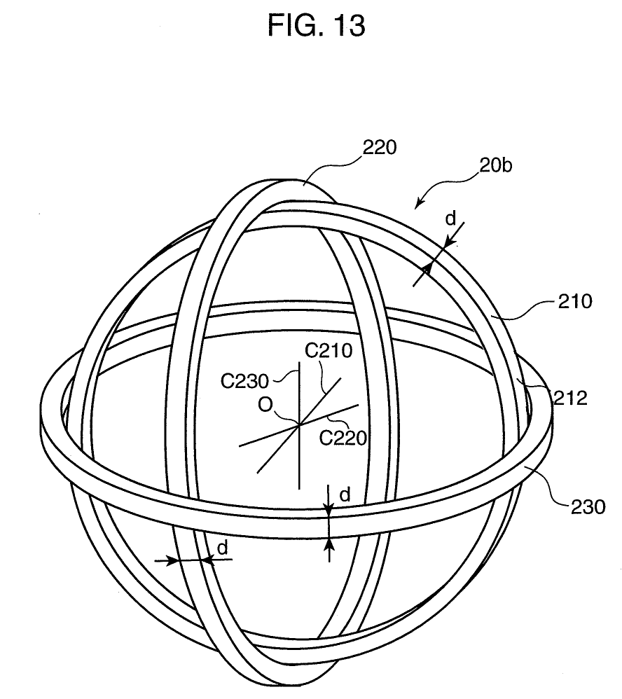

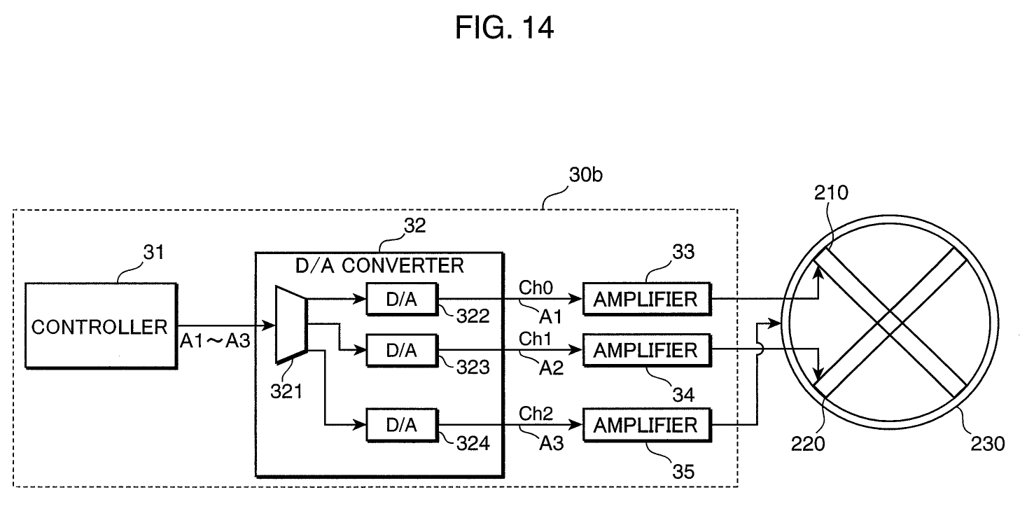

A third embodiment of the present invention is described with reference to FIGS. 13 and 14. Parts common to the orthodontic appliance according to this embodiment and the one according to the first embodiment are identified by the same reference numerals and not described.

The orthodontic appliance according to the third embodiment is provided with three round coils 210, 220, 230 as shown in FIG. 13. These coils 210, 220, 230 are arranged such that central axes C210, C220, C230 thereof orthogonally intersect with each other at a center O. The construction of the coil 230 is identical to those of the coils 210, 220 according to the second embodiment. For example, the winding numbers, diameters and widths of the coils 210 to 230 are respectively equal to each other.

FIG. 14 shows the construction of an alternating current signal generating unit 30b according to the third embodiment. This alternating current signal generating unit 30b is obtained by adding a channel Ch2 and an amplifier 35 corresponding to the coil 230 to the alternating current signal generating unit 30a according to the second embodiment, and a D/A converter 32 additionally includes a D/A converter 324 corresponding to the channel Ch2.

A controller 31 of this alternating current signal generating unit 30b generates digital alternating current signals A1 to A3 to be respectively supplied to the three coils 210 to 230 and outputs them to a multiplexer 321 of the D/A converter 32 while applying time division multiplex thereto. The multiplexer 321 inputs the analog alternating current signal A1 to A3 to the D/A converters 322 to 324 under the control of the controller 31. The D/A converters 322 to 324 analog-to-digital convert the digital alternating current signals A1 to A3 and then input them to the amplifiers 33 to 35. The amplifiers 33 to 35 respectively output the alternating current signals A1 to A3 to the coils 210 to 230 after amplifying them with specified gains.

A user can cause a magnetic field H to be generated in an arbitrary direction in a three-dimensional space by setting the phases, voltages (amplitudes) and frequencies of the alternating current signals A1 to A3 on the operation screen shown in FIG. 10. In the second embodiment, the magnetic field H can be generated only in the horizontal plane S1. The three coils 210 to 230 according to the third embodiment enable the magnitude of the magnetic field H to change in a specific direction in an arbitrary plane passing the center O and the direction of the magnetic field H to rotate, whereby vibration patterns of the permanent magnet 8 are diversified.

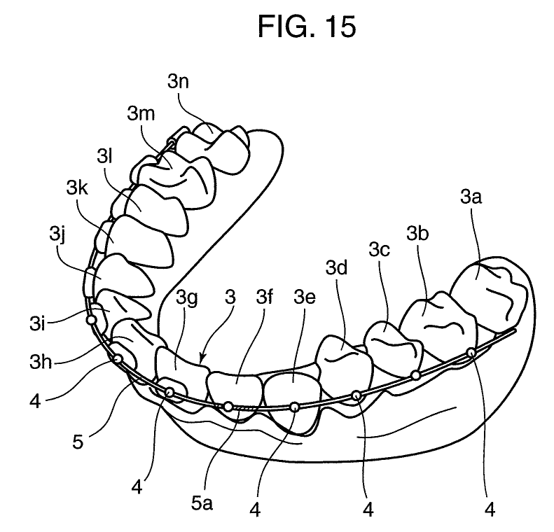

A fourth embodiment of the present invention is described with reference to FIG. 15. FIG. 15 shows a state where braces of an orthodontic appliance according to this embodiment are mounted on teeth 3 of a lower dental arch. The same elements of the fourth embodiment as those of the first to third embodiments are identified by the same reference numerals and are not described.

In the orthodontic appliance according to this embodiment, the braces double as a magnetic element. Specifically, an orthodontic wire 5 constituting the braces is made of a magnetic material. If a suitable alternating current magnetic field is applied to this orthodontic wire 5 in the same way as in the first to third embodiments, the orthodontic wire 5 vibrates to directly apply the vibration (mechanical stimuli) to the teeth 3. In other words, the orthodontic wire 5 promotes an orthodontic action by applying both the elastic restoring force of its own and the mechanical vibration to the teeth.

The use of the orthodontic wire 5 both as the braces and as the magnetic element eliminates the need to provide a magnetic element in addition to the braces and, accordingly, reduces the number of parts. Discomfort given to patients can be alleviated by reducing the number of parts to be attached in the mouths of the patients.

The magnetic element may not constitute the entire orthodontic wire 5, and may constitute at least a part to face a tooth to be aligned. For example, if a tooth 3f shown in FIG. 15 is to be aligned, the promotion of the orthodontic effect can be realized even if only a part 5a of the orthodontic wire 5 facing the tooth 3f is constituted by the magnetic element. Such an orthodontic wire 5 can be formed, for example, by connecting a magnetized wire section for constituting the above part and unmagnetized wire sections for constituting the other parts of the orthodontic wire 5 by welding or the like.

In the above braces, some or all of the brackets 4 may double as the magnetic elements instead of the orthodontic wire 5. In such a case, it is sufficient to make at least the bracket to be attached to the tooth to be aligned of a magnetized material or to make a part of this bracket of a magnet, and it does not matter whether or not the brackets to be attached to the other teeth double as the magnetic elements.

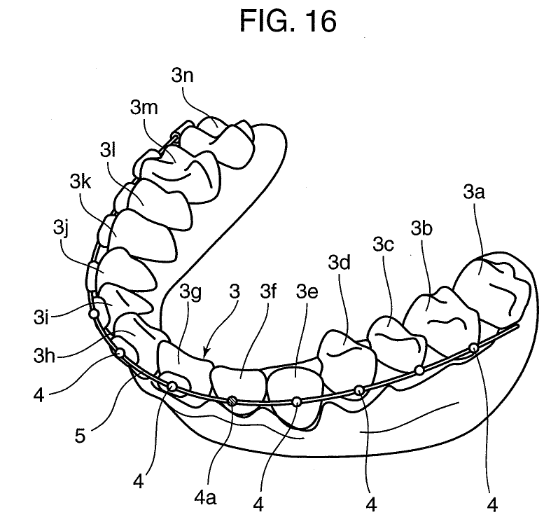

FIG. 16 shows a state where braces including a magnetized bracket 4a are attached to teeth 3 of a lower dental arch. In an example shown in FIG. 16, a tooth 3f is to be aligned, and the magnetized bracket 4a made of a magnetic element is attached to the tooth 3f to be aligned. This bracket 4a vibrates upon receiving a suitable alternating current magnetic field applied thereto as in the first to third embodiments and applies this vibration (mechanical stimuli) to the teeth 3. In this case as well, both the elastic restoring force of the orthodontic wire 5 and the mechanical vibration of the bracket 4a are applied and the mechanical vibration promotes the orthodontic effect by the elastic restoring force.

The simultaneous use of the bracket 4 as a part of the braces and the magnetic element also eliminates the need to provide the magnetic element in addition to the braces and, accordingly, reduces the number of parts. Further, discomfort given to patients can be alleviated by reducing the number of parts to be attached in the mouths of the patients.

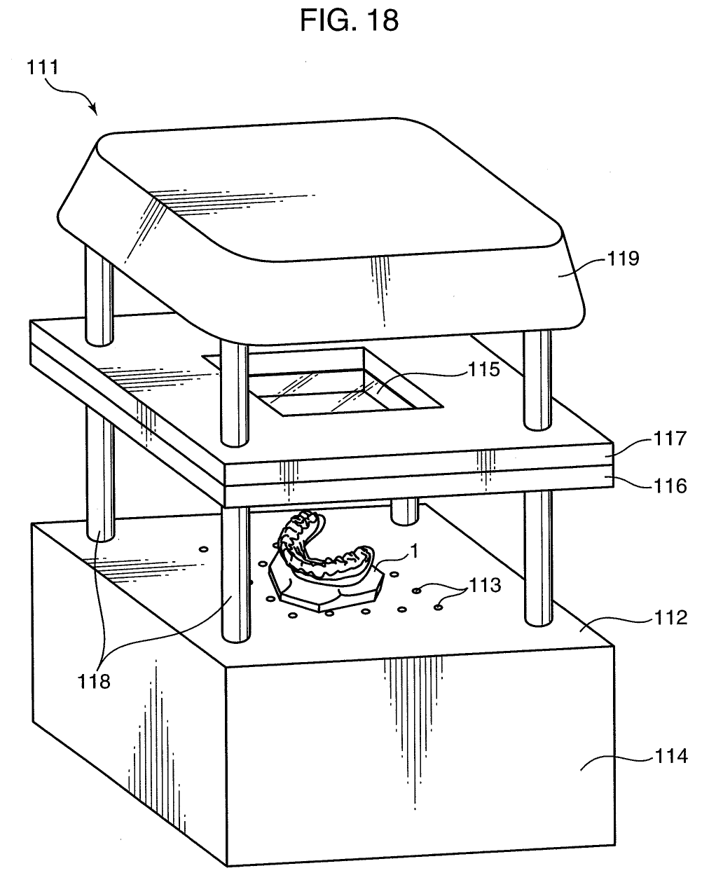

FIG. 18 is a perspective view showing a producing apparatus 111 as one example of an apparatus for producing the dental mouthpiece 7. This producing apparatus 111 is provided with a main body 114, a plurality of supporting columns 118 standing on the main body 114, a pair of sheet fixing devices 116, 117 supported on these supporting columns 118 in such a manner as to be movable upward and downward along the supporting columns 118 and adapted to sandwich an EVA sheet 115 from above and below, and an electric heater 119 mounted on the supporting columns 118. The main body 114 has a stage 112 on which a dental cast 1 can be placed, and has an unillustrated built-in pump for sucking air through a multitude of suction holes 113 formed in the stage 112.

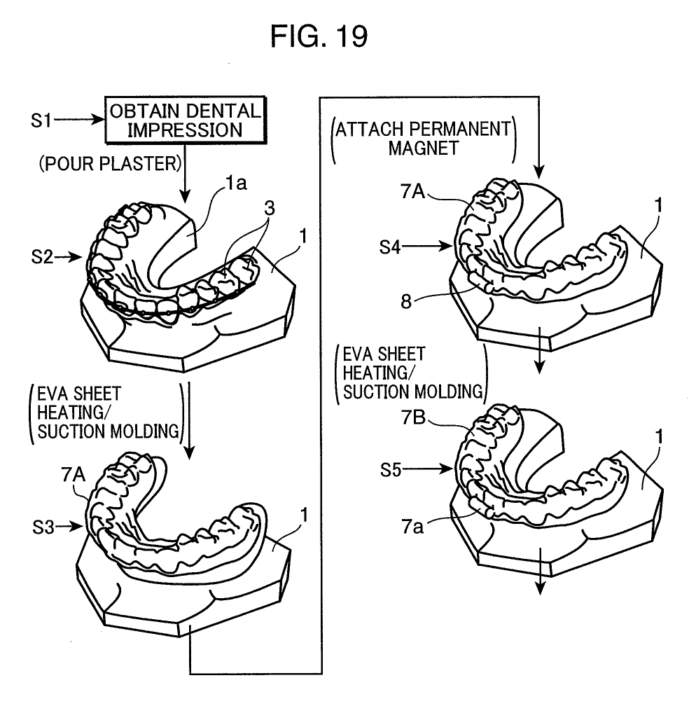

FIG. 19 is a diagram showing a first example of a method for producing the dental mouthpiece 7 using the aforementioned producing apparatus 111.

In Step S1 of FIG. 19, dental impression is performed by attaching an impression material to teeth 3 of a user at a dental clinic. In Step S2, at a dental technician's laboratory or the like, plaster is poured into the impression material retaining the shape of the teeth and is taken out after being hardened, whereby the dental cast 1 is completed. At this time, if the braces including the brackets 4 and the orthodontic wire 5 are mounted on the teeth 3 of the user, the inner layer 7A might be broken or the brackets 4 might be disengaged from the front sides of the teeth by the inner layer 7A getting caught by edges of the braces upon mounting or detaching the dental mouthpiece 7 on or from the teeth 3. In order to prevent such problems, a method for eliminating the edges is effective according to which wax or the like is filled into clearances in parts of the dental cast 1 corresponding to the brackets 4 and the orthodontic wire 5. This method reduces the user' burdens as compared to a method according to which nontoxic wax or the like that can be washed away with water is filled into clearances of the brackets 4 and the orthodontic wire 5 before the dental impression is obtained from the user.

What should be first noted in the producing method shown in FIG. 19 is that the production of the dental mouthpiece 7 proceeds with the inner layer 7A and the outer layer 7B mounted on the dental cast 1. The above dental cast 1 is placed on the stage 112 of the producing apparatus 111 in Step S3. On the other hand, the EVA sheet 115 is operated while being sandwiched by the sheet fixing devices 116, 117. Specifically, by the sheet fixing devices 116, 117 lifted along the supporting columns 118 up to a position near the electric heater 119, the EVA sheet 115 is heated at this position to be softened. After the softening, the EVA sheet 115 is gradually placed on the dental cast 1 by a downward movement of the sheet fixing devices 116, 117.

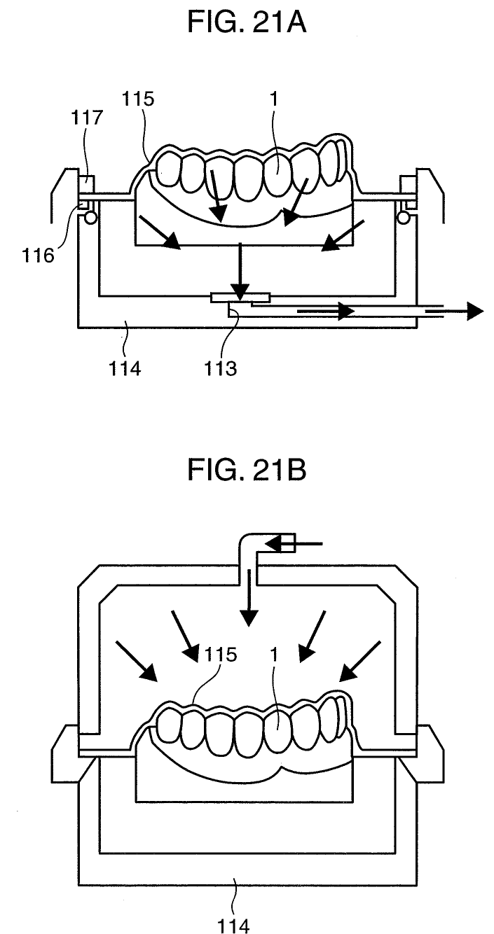

At this time, air suction through the suction holes 113 forms an air flow for closely attaching the EVA sheet 115 to the dental cast 1. In order to enable this suction, a cut 1a is made in the dental cast 1. This suction enables precise dental impression. The principle of such suction casting is only schematically shown in FIG. 21A. The electric heater 119 may also be lowered as the sheet fixing devices 116, 117 are lowered. This downward movement of the electric heater 119 enables continuous heating. Alternatively, as shown in FIG. 21B, the dental mouthpiece can be cast by pressurizing air around the EVA sheet 115. This pressurization and the suction may be applied in combination.

The inner layer 7A is completed by the casting as above. Up to Step S3, this method is the same as the conventional dental mouthpiece producing method. FIG. 19 is shown in FIGS. 2 to 11 on page 15 of “Not Only Mouth Guard! Casting Machine Application Manual” (cowritten by Maeda and Matsuda, published by Quintessence Publisher).

What should be noted next is that the permanent magnet 8 can be attached to the inner layer 7A while the inner layer 7A is still hot in Step S4 according to the producing method of the first example. The material of the dental mouthpiece 7, particularly the above EVA exhibits high viscosity in its molten state to such an extent as to be used also as a main ingredient of so-called hot bond. Accordingly, the inner layer 7A having a high temperature immediately after being cast in a half molten state in Step S3 as described above exhibits high viscosity until it is cooled. An adhesive force given by the material of the inner layer 7A due to the remaining heat of the inner layer 7A can be utilized to mount the permanent magnet 8. Specifically, it is sufficient to press the permanent magnet 8 against the inner layer 7A while the inner layer 7A still has a high temperature. In this way, the permanent magnet 8 can be temporarily fixed without using special fixing means such as adhesive.

If the adhesive force by the viscosity of the inner layer 7A is insufficient, such a shortage may be compensated for. For example, the permanent magnet 8 may be provided with a projection and the inner layer 7A may be formed with a part engageable with this projection, or the heated EVA may be poured into parts to be fixed as auxiliary adhesive.

What should be further noted is that the permanent magnet 8 can be sealed airtight in the inner layer 7A and the outer layer 7B in Step S5 shown in FIG. 19. Specifically, similar to Step S3, the heated EVA sheet 115 is placed on the inner layer 7A fitted with the permanent magnet 8 as described above, and an actuator is caused to suck. In this way, the outer layer 7B is formed and the magnetic element is sealed between the outer layer 7B and the inner layer 7A.

The softening temperature of the EVA sheet 115 as the material for the inner layer 7A and the outer layer 7B is set lower than the heat resistant temperature of the magnetic element. For example, if the permanent magnet 8 having a specified heat resistant temperature set is used as the magnetic element, an EVA sheet having a softening point lower than this heat resistant temperature is selected as the EVA sheet 115. The use of such an EVA sheet enables the EVA sheet to be directly mounted on the permanent magnet 8 and the outer layer 7B to be cast by melting while enabling problems caused by an excessive temperature rise of the magnetic element to be securely prevented. “Bioplast” (product name) can be cited as an example of the EVA having such a low softening point.

If the heat resistant temperature of the vibrating element is even higher, materials having higher softening points can be used instead of EVA materials. Specifically, polyolefin materials having softening points of about 100° C. such as “MG-21” (product name) or PET-E materials having softening points between 100 and 200° C. such as “Duran” (product name) can be used.

The permanent magnet 8 requires no wiring, for example, unlike an electric actuator. This makes it easier to completely build the permanent magnet 8 in the dental mouthpiece 7.

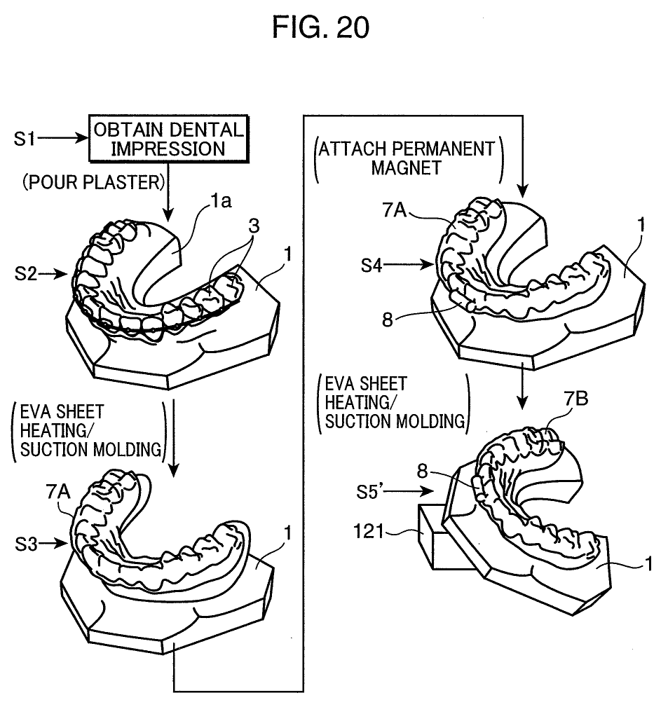

FIG. 20 is a diagram showing a method for producing the dental mouthpiece according to a second example. Since this producing method is similar to the one according to the first example shown in FIG. 19, elements common to both examples are identified by common step numbers and are not described.

What should be noted in the producing method according to this second example is that the step of forming the outer layer 7B in Step S5 shown in FIG. 19 is changed to Step S5′ shown in FIG. 20. In Step S5′, the dental cast 1 having the inner layer 7A fitted with the permanent magnet 8 mounted thereon is set in an inclined state on the stage 112 shown in FIG. 18. This inclination is for preventing the dental cast 1 from being hidden from an air flow by the permanent magnet 8. This inclination can be made by placing a rest 121 as shown in FIG. 20 below a part of the dental cast 1 where the permanent magnet 8 is mounted.

It is sufficient for the material for the inner layer 7A and the outer layer 7B to have a softening point lower than the heat resistant temperature of the permanent magnet 8 and to be harmless to human bodies. The material is arbitrarily selected based on hardness required for the respective pieces 7A, 7B after casting within such a range as to meet these conditions. However, it is preferable to use a soft resin as the material. The use of the soft resin has advantages of alleviating stimuli given to the teeth and gums from the magnetic element, reducing loads given to the teeth and gums, mitigating discomfort such as pains, and improving wearing comfort as compared to hard dental mouthpieces.

On the other hand, the use of a hard resin as the material has advantages of enabling the dental mouthpiece to be precisely cast, less deformation of the dental mouthpiece by the storage environment, and easier quality maintenance. Accordingly, a hard resin may be used in the case of attaching more importance to these advantages.

Further, the material for the inner layer 7A and the one for the outer layer 7B may differ.

For example, a dental mouthpiece having an overlaid structure comprised of an inner layer 7A made of a soft resin and an outer layer 7B made of a hard resin has advantages that the inner layer 7A effectively alleviates impacts of a magnetic element to reduce loads on teeth to be aligned and gums, and the outer layer 7B made of the hard resin is easy to store because it is difficult to deform by the environment, and can be formed to have a precise shape.

Conversely, a dental mouthpiece having an overlaid structure comprised of an inner layer 7A made of a hard resin and an outer layer 7B made of a soft resin has advantages that the outer layer 7B made of the soft resin absorbs impacts during sport and everyday life to effectively suppress damages of the dental mouthpiece and the teeth on which the dental mouthpiece is mounted resulting from the impacts, and the inner layer 7A made of the hard resin enables the production of a dental mouthpiece having a precise inner surface form. Further, this dental mouthpiece can be more easily kept in shape than those entirely made of the soft resin.

Further, even in a dental mouthpiece made up of a single layer without having an overlaid structure as above, it is possible to mixedly provide soft parts, i.e. those for weakly transmitting stimuli to the teeth 3 and hard parts, i.e. those for strongly transmitting stimuli to the teeth 3.

Resins used for the material of the dental mouthpiece are: EVAs→polyolefins→polyesters and the like in a decreasing order of softness. Even the same material has different compound ratios and hardnesses depending on products. Most EVAs are soft materials having a shore hardness of about 80 to 90 and widely used as the material for soft dental mouthpieces. Conversely, most polyesters are hard materials and widely used as the material for hard dental mouthpieces. There are soft polyolefins and hard polyolefins depending on their compound ratios, but polyolefins are generally used as_materials having hardnesses between the EVAs and the polyesters.

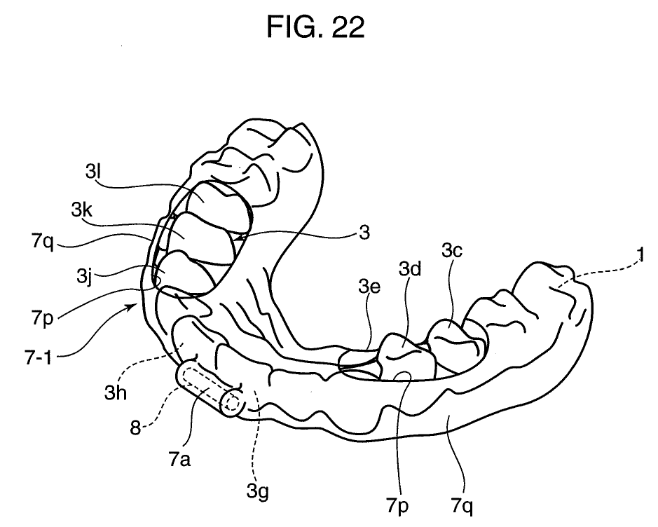

Next, dental mouthpieces according to fifth to eleventh embodiments are described with reference to FIGS. 22 to 28. Each of the dental mouthpieces according to these embodiments has dividing portions by dividing specified parts other than a part corresponding to teeth 3g, 3h to be aligned. These dividing portions suppress the transmission of mechanical vibration generated by a magnetic element so that the mechanical vibration acts restrictedly on the teeth 3g, 3h to be aligned.

FIG. 22 shows a dental mouthpiece 7-1 according to the fifth embodiment. The dividing portions of this dental mouthpiece 7-1 are cutout portions 7p. These cutout portions 7p are formed by cutting out tooth crown portions of the dental mouthpiece 7-1 except at the part corresponding to the teeth 3g, 3h to be aligned. For example, elliptical cutouts are made in the tooth crown portions for teeth 3c to 3e, 3j to 3l in FIG. 22. Tooth root portions 7q left in the dental mouthpiece 7-1 at the parts where the cutout portions 7p are formed integrally connect parts before and after the cutout portions 7p.

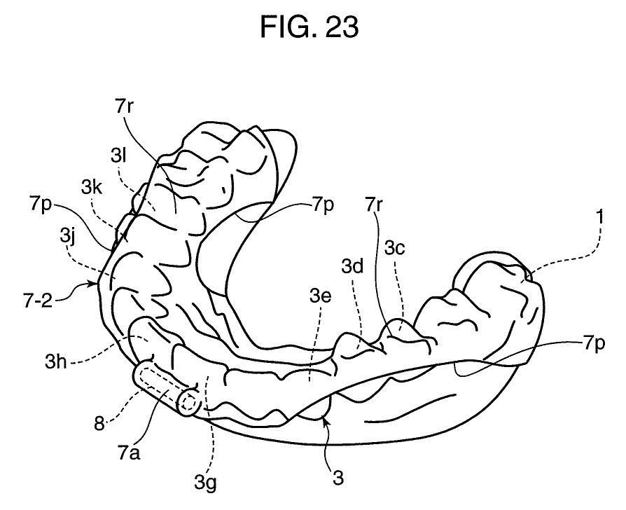

FIG. 23 shows a dental mouthpiece 7-2 according to the sixth embodiment. The dividing portions of this dental mouthpiece 7-2 are also cutout portions 7p. These cutout portions 7p are formed by cutting out tooth root portions of the dental mouthpiece 7-2 except at the part corresponding to the teeth 3g, 3h to be aligned. For example, elliptical cutouts are made in the tooth root portions for the teeth 3c to 3e, 3j to 3l in FIG. 23. Tooth crown portions 7r left in the dental mouthpiece 7-2 except at the parts where the cutout portions 7p are formed integrally connect parts before and after the cutout portions 7p.

In the dental mouthpieces 7-1, 7-2, the permanent magnet 8 for generating mechanical vibration is stored at the part corresponding to the teeth 3g, 3h to be aligned, and the cutout portions (dividing portions) 7p for suppressing the transmission of the mechanical vibration are formed in the parts other than the one corresponding to the teeth 3g, 3h to be aligned. This enables the partial and precise application of vibration to the teeth 3g, 3h to be aligned.

The cutout portions 7p are formed by a post-processing of, e.g. cutting off the tooth crown portions or the tooth root portions of the dental mouthpiece 7 shown in FIG. 1 using a cutter knife or the like. Accordingly, the dental mouthpieces 7-1, 7-2 having these cutout portions 7p can be easily produced. For example, a dental mouthpiece having the above cutout portions 7p can be easily produced through this post-processing from a dental mouthpiece actually worn by a user.

By connecting the parts before and after the cutout portions 7p by the tooth root portions 7q or the tooth crown portions 7r left in the dental mouthpieces 7-1, 7-2, the shapes of the dental mouthpieces 7-1, 7-2 can be so kept as to be entirely mountable on the teeth 3. Such shapes facilitate an operation of mounting the dental mouthpieces 7-1, 7-2 on the teeth 3, thereby enabling the permanent magnet 8 to be precisely positioned at the part corresponding to the teeth 3g, 3h to be aligned in the worn state.

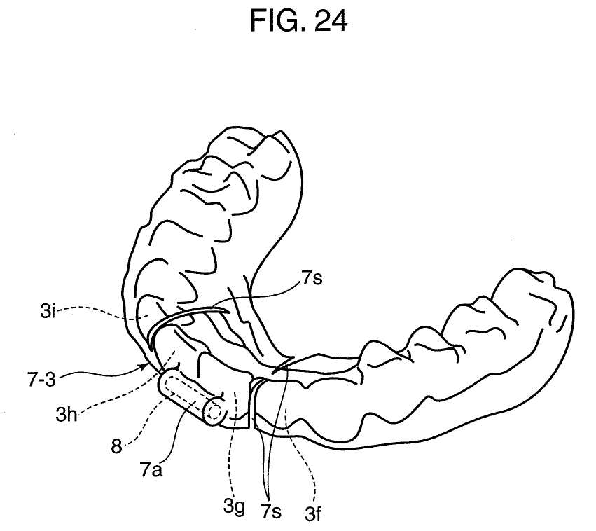

FIG. 24 shows a dental mouthpiece 7-3 according to the seventh embodiment. The dividing portions of this dental mouthpiece 7-2 are slit portions 7s formed in parts of the dental mouthpiece 7-3 except a part corresponding to the teeth 3g, 3h to be aligned. These slit portions 7s are formed in parts between the teeth 3f, 3g and between the teeth 3h, 3i in FIG. 24, and parts before and after the respective slit portions 7s are integrally connected. The right slit portions 7s in FIG. 24 extend from a tooth root side toward a tooth crown side, whereas the left slit portion 7s extends from the tooth crown side toward the tooth root side. In the present invention, the directions of these slit portions are not limited.

The dental mouthpiece 7-3 according to this seventh embodiment can achieve functions and effects similar to those of the dental mouthpieces 7-1, 7-2.

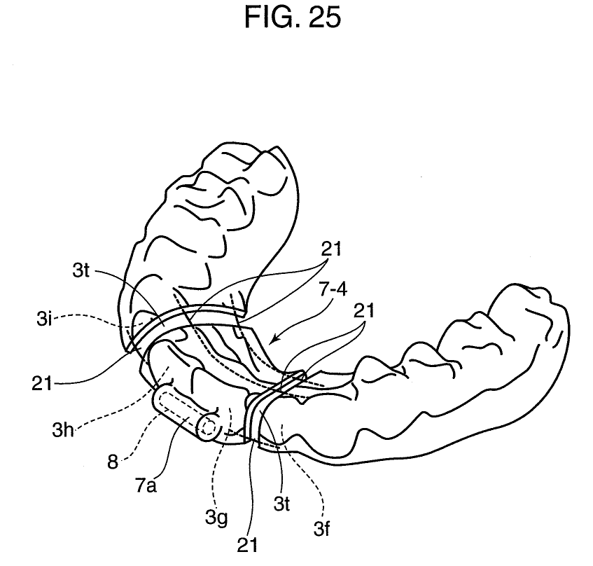

FIG. 25 shows a dental mouthpiece 7-4 according to the eighth embodiment. The dividing portions of this dental mouthpiece 7-4 are cut portions 7t formed by cutting parts except at the one corresponding to the teeth 3g, 3h to be aligned. In FIG. 25, the cut portions 7t are formed by making cuts between the teeth 3f, 3g and between 3h, 3i, and parts before and after the respective cut portions 7t are integrally connected, for example, by means of wires 21 or the like insert-cast in the dental mouthpiece 7-4.

The dental mouthpiece 7-4 according to this eighth embodiment can also achieve functions and effects similar to those of the dental mouthpieces 7-1, 7-2 and 7-3.

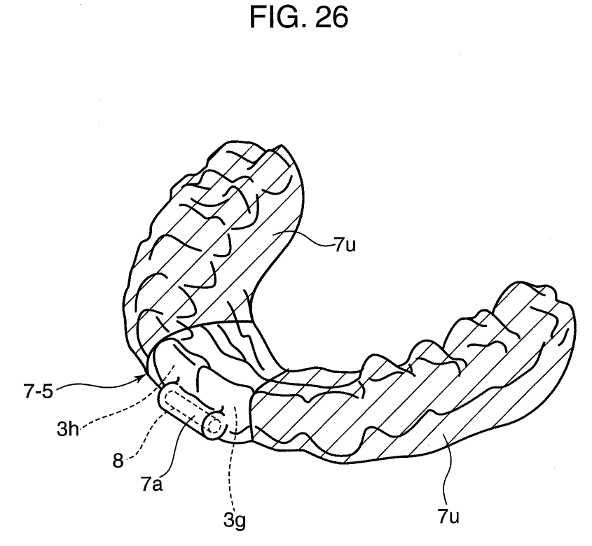

FIG. 26 shows a dental mouthpiece 7-5 according to the ninth embodiment. The dividing portions of this dental mouthpiece 7-5 are soft portions 7u made of a soft material. In this dental mouthpiece 7-5, the part corresponding to the teeth 3g, 3h to be aligned is made of an ordinary mouthpiece material, whereas the other parts (parts hatched with oblique lines in FIG. 26) are made of the soft material less likely to transmit the mechanical vibration to form the soft portions 7u.

The dental mouthpiece 7-5 according to this ninth embodiment can also achieve functions and effects similar to those of the dental mouthpieces 7-1, 7-2, 7-3 and 7-4. Further, the dental mouthpiece 7-5 has an advantage of having no clearances such as the cutout portions 7p and the slit portions 7s.

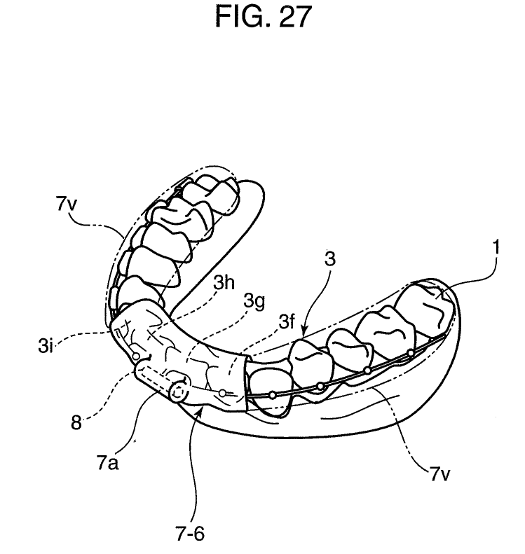

FIG. 27 shows a dental mouthpiece 7-6 according to the tenth embodiment. The dividing portions of this dental mouthpiece 7-6 are cutoff portions 7v shown by chain double-dashed line. These cutoff portions 7v are formed by cutting off parts of the dental mouthpiece 7-4 at least except the one corresponding to the teeth 3g, 3h to be aligned (teeth 3f, 3i near the teeth 3g, 3h to be aligned are also included in FIG. 27). Accordingly, this dental mouthpiece 7-6 is mounted only on the teeth 3g, 3h to be aligned (or on the teeth 3g, 3h to be aligned and their neighboring teeth 3f, 3i).

The dental mouthpiece 7-6 according to this tenth embodiment can also achieve functions and effects similar to those of the dental mouthpieces 7-1, 7-2, 7-3, 7-4 and 7-5.

The dental mouthpiece 7-6 may be mounted on only a single tooth. For example, the dental mouthpiece 7-6 may be so shaped and constructed as to be mounted only on one tooth 3g or 3h to be aligned.

In the case where all the teeth 3a to 3n are to be aligned, the dental mouthpiece 7-6 may be individually mounted on each of the teeth 3a to 3n to be aligned. In such a case, the dental mouthpiece 7-6 can be successively detached from the teeth for which an orthodontic treatment has been finished. Alternatively, the dental mouthpiece 7-6 can be successively mounted and detached. For example, a treatment is first conducted by mounting the dental mouthpiece 7-6 on the teeth at the back side, and the dental mouthpiece 7-6 is detached after the orthodontic treatment is finished. A subsequent treatment is conducted by mounting the dental mouthpiece 7-6 on the teeth before the already treated teeth. In this way, it is also possible to successively mount and detach the dental mouthpiece 7-6 on and from the teeth from the posterior tooth side toward the front tooth side.

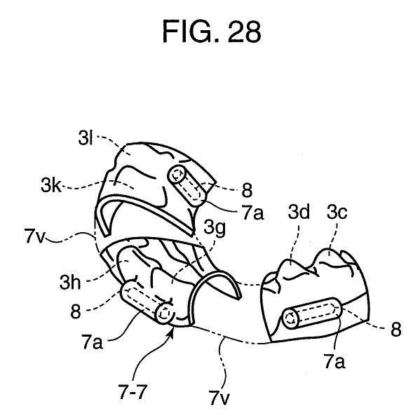

FIG. 28 shows a dental mouthpiece 7-7 according to the eleventh embodiment. The dividing portions of this dental mouthpiece 7-7 are cutoff portions 7v (see chain double-dashed line) formed by cutting off the dental mouthpiece 7-7 except at parts corresponding to the teeth 3c, 3d to be aligned, the teeth 3g, 3h to be aligned and the teeth 3k 3l to be aligned. Accordingly, the dental mouthpiece 7-7 is mounted only on the teeth 3c, 3d to be aligned, the teeth 3g, 3h to be aligned and the teeth 3k 3l to be aligned.

The dental mouthpiece 7-7 according to this eleventh embodiment can also achieve functions and effects similar to those of the dental mouthpieces 7-1, 7-2, 7-3, 7-4, 7-5 and 7-6.

The dental mouthpiece 7-7 is divided into a plurality of (three in this example) mutually independent segments by the cutoff portions (dividing portions) 7v. In this construction, the direction and intensity of the vibration to be applied can be changed for each segment, which enables adaptations to various teethes and bites. Further, one or more permanent magnets 8 can be stored for each segment.

Since the parts before and after the divided sections are integrally connected to each other in the dental mouthpieces 7-1 to 7-4 according to the fifth to eighth embodiments, each dental mouthpiece is entirely formed by a single segment, but the parts before and after the dividing portions can be seen as the mutually independent segments since the respective dividing portions suppress the transmission of the mechanical vibration. Accordingly, in a construction in which the permanent magnets 8 are stored in the segments before and after the dividing portions similar to the dental mouthpiece 7-7 according to the eleventh embodiment, the direction and intensity of the vibration to be applied can be changed for each segment, thereby enabling adaptations to various teethes and bites. Further, it is also possible to store one or more magnetic elements in each segment.

Since the dividing portions are the cutout portions 7p, the slit portions 7s or the cut portions 7t in the dental mouthpiece 7-1 to 7-4 according to the fifth to eighth embodiments, the segments unnecessary for the treatment by a treatment plan or the segments having used for the already finished orthodontic treatment can be locally removed by being cut at the dividing portions if the magnetic elements are stored in the respective segments before and after the dividing portions. It is more preferable to have such a construction that the parts cut at the dividing portions can be reconnected. This construction can be realized, for example, by mounting fittings attachable to and detachable from each other, magnetic elements attracting each other, adhesive materials or the like at the cut positions.

The dental mouthpieces 7-1 to 7-7 according to the above embodiments are not limited to those having an inner and outer overlaid structure comprised of the inner layer 7A and the outer layer 7B. In short, it is sufficient to store the magnetic element at the part corresponding to the tooth to be aligned.

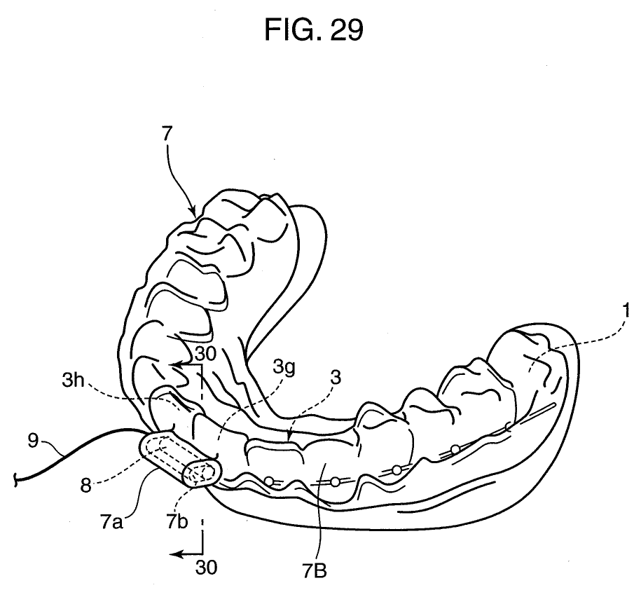

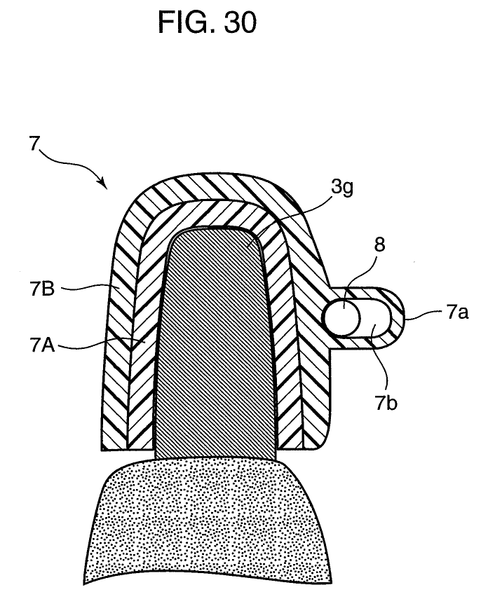

FIG. 29 is a perspective view showing a state where a dental mouthpiece according to a twelfth embodiment of the invention is mounted on the lower dental arch of a user, and FIG. 30 is a section along the line 40-40 of FIG. 29.

The dental mouthpiece 7 according to this embodiment is characterized by the shape of a storage space of a magnetic element storing portion. This storage space is so shaped as to provide the magnetic element with a play permitting the magnetic element itself to move in the storage space.

In FIG. 29, an outer layer 7B constituting the dental mouthpiece 7 is formed with a bulge portion 7a similar to the first embodiment, and a permanent magnet 8 as a magnetic element is stored in this bulge portion 7a. This permanent magnet 8 has a cylindrical shape and is stored in the bulge portion 7a in such a posture that a direction of the central axis thereof is a horizontal direction (transverse direction) along the teeth 3.

On the other hand, a storage space 7b formed in the bulge portion 7a, i.e. a space for storing the permanent magnet 8 has a cylindrical shape whose cross section normal to longitudinal direction has an elliptical shape longer in horizontal direction. Accordingly, the shape of the storage space 7b is larger than the outer shape of the permanent magnet 8 and provides a clearance or a play extending in horizontal direction (inward and outward directions of the buccal cavity).

The storage space 7a according to this embodiment permits the permanent magnet 8 to be displaced along horizontal direction (inward and outward directions of the buccal cavity) without completely restraining the permanent magnet 8, i.e. provides the permanent magnet 8 with a play. Accordingly, a vibration load generated by the permanent magnet 8 as the magnetic element causes the permanent magnet 8 itself to vibrate along the direction of the above clearance (horizontal direction) and to collide with the wall surface defining the storage space 7b. This collision load amplifies vibration to be applied to the teeth 3 of the user wearing the dental mouthpiece 7, thereby further improving the orthodontic effect by that much.

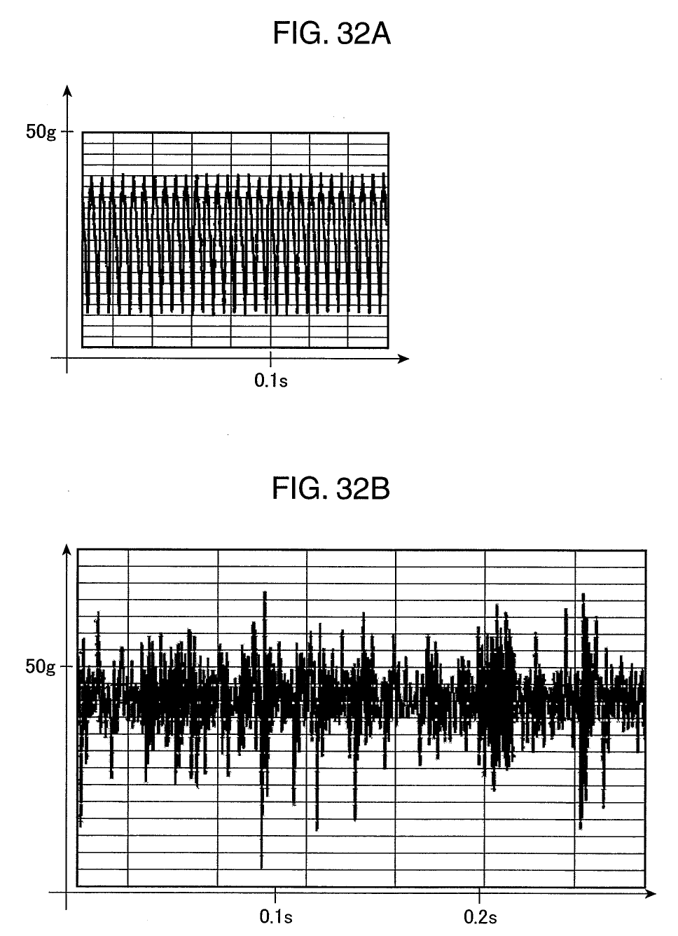

FIG. 32 are graphs showing an experiment result obtained by the inventors of the present application. FIG. 32A shows the amplitude of vibration to be applied to the teeth 3g, 3h to be aligned from a dental mouthpiece 7 whose storage space 7b has a shape equal to the outer shape of the permanent magnet 8, i.e. a dental mouthpiece 7 in which the permanent magnet 8 is completely restrained in the storage space 7 as a reference example, and FIG. 32B shows the amplitude of vibration in the case where a play is provided in the storage space 7b as shown in FIG. 29.

FIG. 32A shows that regular vibration of about 200 Hz is applied with a vibration load of about 30 g by the eccentric weight of the permanent magnet 8 in the case where the permanent magnet 8 is completely restrained in the storage space 7b. On the other hand, FIG. 32B shows that vibration is irregular, but the vibration load is increased (doubled) up to about 60 g in the case where there is the play.

In this embodiment, the direction of the play (direction of the clearance) coincides with a direction conforming to the aligning direction of the teeth 3g, 3h to be aligned in the storage space 7b. This largely contributes to the promotion of the orthodontic effect.

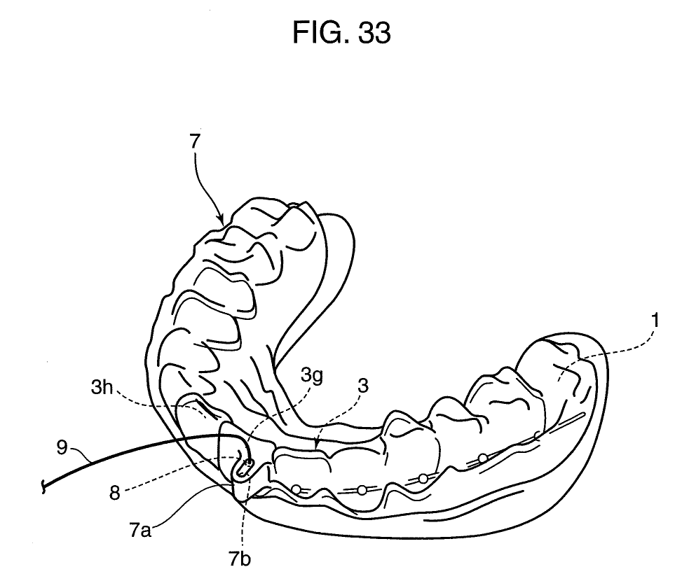

For example, in the case of retracting a tooth sticking out forward and in the case of pulling a retracted tooth forward, the direction of the clearance may coincide with forward and backward directions. Further, in the case of aligning a twisted tooth, the direction of the clearance may coincide with a direction in which the tooth should be twisted back and which is substantially normal to the tooth surface. In an example shown in FIG. 33, the direction of the clearance is set to be substantially normal to the right half of the tooth surface of the tooth 3g to be aligned, which is supposed to be twisted in counterclockwise direction when viewed from above.

A vibration effect utilizing such a clearance enables the application of the vibration load having high directivity to the teeth.

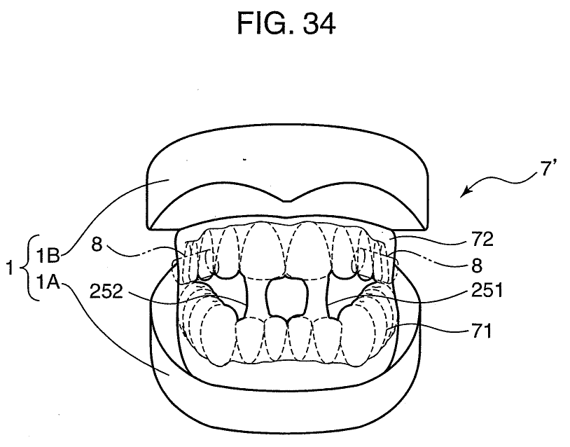

A thirteenth embodiment of the present invention is described with reference to FIG. 34. FIG. 34 is a perspective view showing a state where a dental mouthpiece 7′ according to one embodiment of the present invention is mounted on a dental cast 1 of a user. The dental mouthpiece 7′ of this embodiment includes a lower layer 71 corresponding to a dental cast 1A of the lower dental arch, an upper layer 72 corresponding to a dental cast 1B of the upper dental arch, connecting members 251, 252 connecting both layers 71, 72 at positions distanced from teeth to be aligned, and permanent magnets 8 as one example of magnetic elements. The upper layer 72 is mountable on the upper teeth, and the lower layer 71 is mountable on the lower teeth.

The lower layer 71 and the upper layer 72 of this dental mouthpiece 7′ are both produced using an apparatus equivalent to the producing apparatus 111 shown in FIG. 18 by a method equivalent to the producing method shown in FIG. 19. Thereafter, the connecting members 251, 252 are formed in the following manner.

First, the lower layer 71 and the upper layer 72 produced as above are mounted on corresponding dental casts 1A, 1B of the dental cast 1 having the bite thereof adjusted. Subsequently, EVA columns having the opposite ends thereof heated to be molten are caused to stand at specified positions of the lower layer 71 with both dental casts 1A, 1B opened, and then the dental casts 1A, 1B are closed up to a specified angle. In this way, the ends of the EVA columns at an opposite side come into contact with the upper layer 72. The EVA columns become the connecting members 251, 252 connecting both layers 71, 72 by being cooled in this state, whereby a pair of upper and lower dental mouthpieces 7′ is completed.

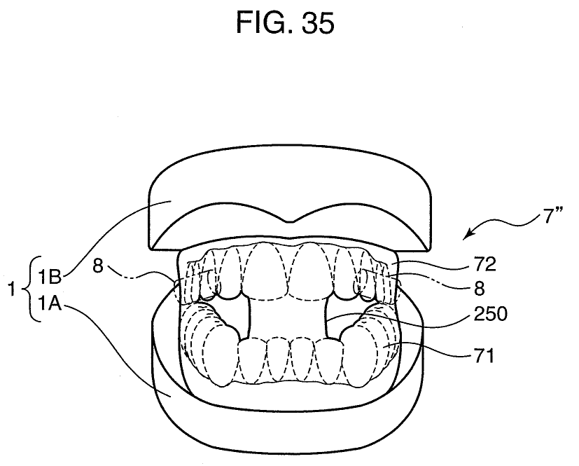

The connecting members 251, 252 are provided at the positions distanced from the teeth to be aligned between the upper and lower layers 72, 71. For example, if the teeth to be aligned are left and right molar teeth (e.g. teeth 3a to 3d and 3k to 3n in the teeth shown in FIG. 1) and the permanent magnets 8 are built in the dental mouthpiece 7′ at positions near these teeth as shown in FIG. 34, the connecting members 251, 252 may be formed at the positions near the front teeth (central incisors) 3g, 3h as shown in FIG. 34. Alternatively, only a single connecting member 250 may be formed as in a dental mouthpiece 7″ shown as a fourteenth embodiment in FIG. 35. On the other hand, if the teeth to be aligned are front teeth (lateral incisors) 3f, 3i and front teeth (canine teeth) 3e, 3j shown in FIG. 1 and the permanent magnet 8 is built in at the position shown in FIG. 2, the connecting members may be formed at the left and right posterior teeth or their neighboring positions (e.g. at positions of the teeth 3c, 3d and teeth 3k, 3l of FIG. 1 or at their neighboring positions).

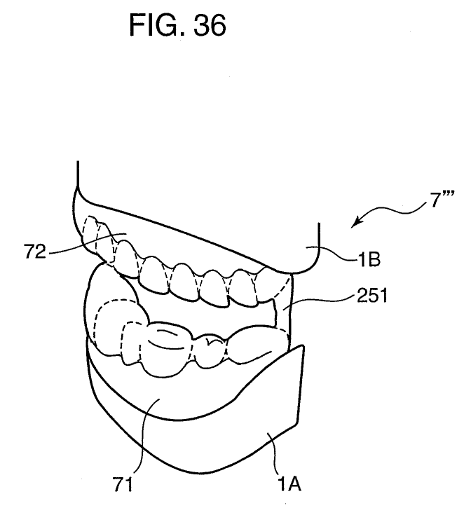

In a dental mouthpiece 7″′ shown as a fifteenth embodiment in FIG. 36, the left and right connecting members (only left connecting member 251 is shown in FIG. 36) are provided at positions more toward the posterior teeth than the molar teeth. The connecting members provided at such positions enable no load caused by the bite to be applied to any of the front teeth (central incisors) 3g, 3h, the front teeth (lateral incisors) 3f, 3i, the front teeth (canine teeth) 3e, 3j, the molar teeth 3a to 3d, 3k to 3n as shown in FIG. 1. In other words, the open state can be kept. Such a dental mouthpiece is suitable in the case of aligning the entire teeth.

In the dental mouthpieces including the respective connecting members, the biting state (bite force and biting surfaces) of the upper layer 72 and the lower layer 71 can be kept constant at the position(s) where the permanent magnet 8 is provided. This prevents a change in the vibration transmission mode caused by an unconscious behavior of the user to bite the permanent magnet 8 or its neighboring part. In other words, this eliminates the need for the user to make an effort to keep the dental mouthpiece open, whereby a good orthodontic effect can be obtained by continuing to apply specified vibration to the teeth to be aligned while reducing burdens on the user.

The inner surface form of the dental mouthpiece according to the present invention is preferably in conformity with the dental cast 1 of the user wearing braces including the orthodontic wire 5 and the brackets 4. The dental mouthpiece reflecting the shape of the braces can be mounted on the teeth wearing the braces, and can be used in combination with the braces.

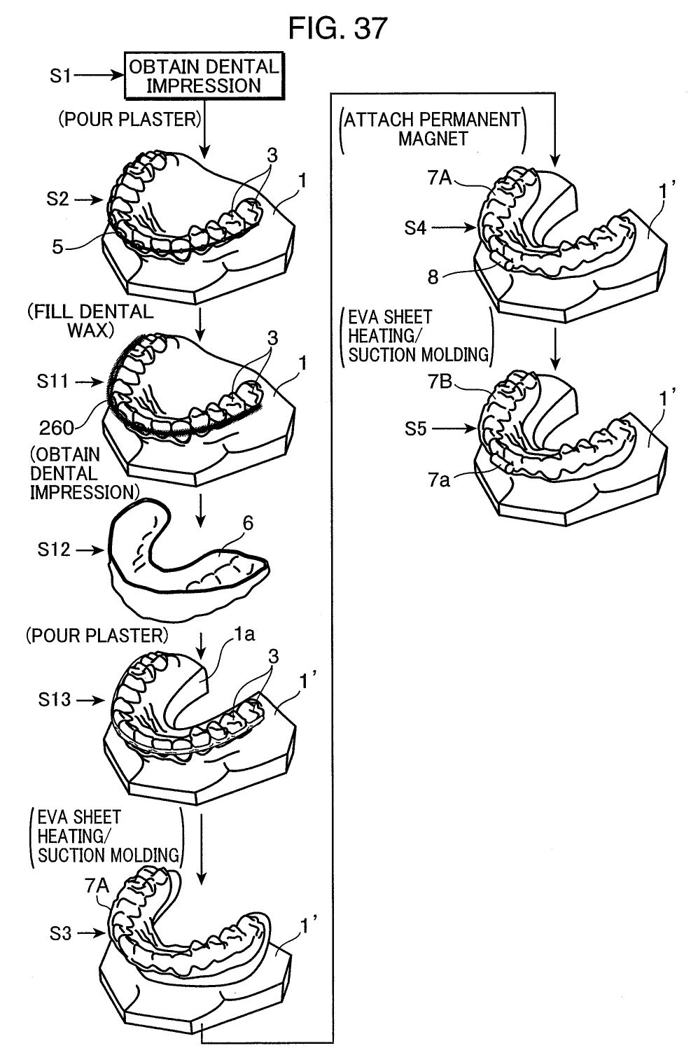

FIG. 37 is a diagram showing a method for producing such a dental mouthpiece. What should be noted here is that a dental impression is obtained with the brackets 4 and the orthodontic wire 5 mounted on the dental cast 1 (Step S1) and the dental cast 1 is completed (Step S2). Thereafter, dental wax 260 is filled into clearances in parts of the dental cast 1 corresponding to the brackets 4 and the orthodontic wire 5 to thereby eliminate unevenness in Step S11. So-called “paraffin wax” or the like can be used as the dental wax. This material is solid at normal temperature, and is used in liquid state by being heated and molten using an alcohol lamp or the like.

This method reduces burdens on the user as compared to the method according to which the wax is used upon obtaining the dental impression in Step S1, i.e. the method according to which the dental impression is obtained after nontoxic wax or the like that can be washed away with water is filled into clearances of the brackets 4 and the orthodontic wire 5 with the user wearing the brackets 4 and the orthodontic wire 5.

Further, in Step S12, the inner surface form of the impression material 6 obtained using silicon corresponds to an envelope of the outer shape of the braces including the bracket 4 and the orthodontic wire 5. This shape is such a shape capable of avoiding the interference of the unevenness of the braces with the inner surface of the dental mouthpiece to be cast, and a clearance is defined between the inner surface of the impression material and the buccal surface of the teeth 3. Thereafter, plaster is poured into the impression material 6 and taken out after being hardened, whereby a dental cast 1′ actually used for the production of the dental mouthpiece 7 is completed. Processes after Step S13 are equivalent to the method shown in FIG. 19.

The inner surface form of the inner layer 7A of the dental mouthpiece 7 thus produced conforms to the dental cast 1 of the user wearing the braces including the orthodontic wire 5 and the brackets 4. In other words, since the inner surface of this dental mouthpiece 7 reflects the shape of the braces, the dental mouthpiece 7 is mountable on these braces, which enables the simultaneous use of the dental mouthpiece 7 and the braces.

Further, since the inner surface form of the inner layer 7A corresponds to the shape of the braces including the orthodontic wire 5 and the brackets 4 after having the unevenness reduced and reflects this uneven shape as clearances, the interference of the sharp orthodontic wire 5 and the brackets 4 with the inner layer 7A can be reduced. This prevents the braces from being displaced or coming off and the dental mouthpiece 7 from being damaged when the braces and dental mouthpiece 7 are mounted and detached.

As described above, the present invention is directed to an orthodontic appliance for aligning a teeth, comprising braces to be mounted on a specified tooth included in the teeth to align the teeth, a magnetic field generator, and a magnetic element to be attached to the teeth so as to vibrate in response to a magnetic field generated by the magnetic field generator and apply the vibration to the tooth on which the braces are mounted.

The present invention is also directed to an orthodontic method for aligning a teeth, comprising a step of mounting braces on a specified tooth included in the teeth to align the teeth, a step of attaching a magnetic element to the teeth, and a step of forming a magnetic field for vibrating the magnetic element attached to the teeth and applying the vibration of the magnetic element to the tooth on which the braces are mounted.

According to these appliance and method, the magnetic element attached to the teeth is vibrated by the magnetic field and this vibration is applied to the tooth on which the braces are mounted. This application of the vibration promotes an orthodontic effect by the braces to shorten a period of orthodontic treatment. The magnetic element needs not be physically directly connected with the magnetic field generator used to vibrate the magnetic element. Accordingly, unlike the case where the vibration is generated using, for example, an electric actuator, wiring for power supply and the wearing of the magnetic field generator by a patient are unnecessary. This enables the patient to freely move without being annoyed by the wiring within the range of the magnetic field generated by the magnetic field generator, thereby alleviating burdens on the patient.

The magnetic field generator preferably includes one or more coils for generating the magnetic field by receiving the supply of a current.

For example, if the magnetic field generator includes two round coils arranged such that the central axes thereof intersect with each other, the magnetic element can be vibrated along an arbitrary direction in a specific plane.

If the magnetic field generator includes three round coils arranged such that the central axes thereof intersect with each other, the magnetic element can be vibrated along an arbitrary direction in a three-dimensional space.

If the magnetic field generator includes Helmholtz coils, an area where the intensity of the magnetic field is uniform is extended. Such extension of the area enables the magnetic element to vibrate at a stable torque even if the head inadvertently moves, whereby burdens on a patent being treated can be reduced.

According to the present invention, a dental mouthpiece to be mounted on a tooth (teeth) may be further provided, and the magnetic element may be attached to this dental mouthpiece. A user can easily attach the magnetic element to the teeth by mounting the dental mouthpiece having the magnetic element attached thereto in this way on the teeth.

In this case, it is more preferable that the dental mouthpiece includes a dividing portion at a part thereof except the one corresponding to the tooth to be aligned; and that this divided portion suppresses the transmission of mechanical vibration generated by the magnetic element so that the mechanical vibration acts restrictedly on the part including the tooth to be aligned.

This construction enables the vibration to be restrictedly applied to the tooth to be aligned.

The dental mouthpiece including the dividing portion preferably has, for example, any one of the following constructions in order to facilitate the production thereof.

a) The dividing portion of the dental mouthpiece is a cutout portion formed by cutting out either a tooth root portion or a tooth crown portion of the dental mouthpiece except at the tooth to be aligned, and the other part integrally connects parts of the dental mouthpiece before and after the cutout portion.

b) The dividing portion of the dental mouthpiece is a slit portion formed in a part of the dental mouthpiece except at the tooth to be aligned, and parts of the dental mouthpiece before and after this slit portion are connected to each other.

c) The dividing portion of the dental mouthpiece is a cut portion formed by cutting a part of the dental mouthpiece except at the tooth to be aligned, and parts of the dental mouthpiece before and after this cut portion are connected via a member separate from the one forming the cut portion.

d) The dividing portion of the dental mouthpiece is a cutoff portion formed by cutting off a part of the dental mouthpiece except at the tooth to be aligned, and this cutoff portion is formed at such a position that the dental mouthpiece is so shaped as to be mounted only on the tooth to be aligned.

e) The dividing portion of the dental mouthpiece is a cutout portion formed by cutting out either a tooth root portion or a tooth crown portion of the dental mouthpiece except at the tooth to be aligned, and parts of the dental mouthpiece before and after the cutout portion are integrally connected by the remaining part of the dental mouthpiece.

It is more preferable that the dental mouthpiece includes a storage space for storing the magnetic element inside; and that this storage space has such a shape as to provide the magnetic element with a play permitting the magnetic element itself to move in the storage space.

The play permits the magnetic element itself to move in the storage space by a vibration load generated by the magnetic element. The magnetic element permitted to make such movements collides with the inner surface of the dental mouthpiece enclosing the storage space. Loads caused by this collision can increase the vibration applied to the teeth of the user wearing the dental mouthpiece.

The storage space is particularly preferably shaped such that a clearance is formed in the storage space in a direction corresponding to an aligning direction of the tooth to be aligned. Such a shape enhances the directivity of the vibration to be applied to the tooth to be aligned.

The magnetic element may partly or entirely constitute the braces. Since this magnetic element doubles as the braces, the construction can be simplified by reducing the number of parts of the entire appliance.

Specifically, if the braces include an orthodontic wire and brackets for fixing the orthodontic wire to the teeth, the magnetic element may partly or entirely constitute the orthodontic wire or may constitute some or all of the brackets.

The direction and magnitude of the magnetic field generated by the magnetic field generator can be variously set depending on the specification of the magnetic field generator. For example, a so-called alternate magnetic field whose direction is fixed and whose magnitude cyclically changes can linearly vibrate the magnetic element. Further, a magnetic field whose direction rotates in a specific plane and whose magnitude cyclically changes can change the vibrating direction of the magnetic element with time. The magnitude of the magnetic field is preferably within a range from 0.15 mT (inclusive) to 0.18 (inclusive). Magnetic fields within this range are known to provide a bone formation promoting effect. A synergic effect of this effect and the effect of the magnetic field to apply mechanical vibration to the teeth via the magnetic element further enhances the bone formation promoting effect, thereby even shortening the period of treatment.

1. An orthodontic appliance for aligning teeth, comprising:
braces to be mounted on a specified tooth included in the teeth to align the teeth;
a magnetic field generator; and
a magnetic element to be attached to the teeth so as to vibrate in response to a magnetic field generated by the magnetic field generator and apply the vibration to the tooth on which the braces are mounted.

2. An orthodontic appliance according to claim 1, wherein the magnetic field generator includes one or more coils for generating the magnetic field by receiving the supply of a current.

3. An orthodontic appliance according to claim 2, wherein the magnetic field generator includes two round coils arranged such that the central axes thereof intersect with each other.

4. An orthodontic appliance according to claim 2, wherein the magnetic field generator includes three round coils arranged such that the central axes thereof intersect with each other.

5. An orthodontic appliance according to claim 2, wherein the magnetic field generator includes Helmholtz coils.

6. An orthodontic appliance according to claim 1, further comprising a dental mouthpiece to be mounted on teeth, wherein the magnetic element is attached to the dental mouthpiece.

7. An orthodontic appliance according to claim 6, wherein:
the dental mouthpiece includes a dividing portion at a part thereof except the one corresponding to the tooth to be aligned; and
the divided portion suppresses the transmission of the mechanical vibration generated by the magnetic element so that the mechanical vibration acts restrictedly on the part including the tooth to be aligned.

8. An orthodontic appliance according to claim 7, wherein the dividing portion of the dental mouthpiece is a cutout portion formed by cutting out either one of a tooth root portion and a tooth crown portion of the dental mouthpiece except at the tooth to be aligned; and the other part integrally connects parts of the dental mouthpiece before and after the cutout portion.

9. An orthodontic appliance according to claim 7, wherein the dividing portion of the dental mouthpiece is a slit portion formed in a part of the dental mouthpiece except at the tooth to be aligned; and parts of the dental mouthpiece before and after the slit portion are connected to each other.

10. An orthodontic appliance according to claim 7, wherein the dividing portion of the dental mouthpiece is a cut portion formed by cutting a part of the dental mouthpiece except at the tooth to be aligned, and parts of the dental mouthpiece before and after this cut portion are connected via a member separate from the one forming the cut portion.

11. An orthodontic appliance according to claim 7, wherein the dividing portion of the dental mouthpiece is a cutoff portion formed by cutting off a part of the dental mouthpiece except at the tooth to be aligned, and the cutoff portion is formed at such a position that the dental mouthpiece is so shaped as to be mounted only on the tooth to be aligned.

12. An orthodontic appliance according to claim 6, wherein the dental mouthpiece includes a storage space for storing the magnetic element inside; and the storage space has such a shape as to provide the magnetic element with a play permitting the magnetic element itself to move in the storage space.

13. An orthodontic appliance according to claim 12, wherein the storage space is shaped such that a clearance is formed in the storage space in a direction corresponding to an aligning direction of the tooth to be aligned.

14. An orthodontic appliance according to claim 1, wherein the magnetic element partly or entirely constitutes the braces.

15. An orthodontic appliance according to claim 14, wherein:
the braces include an orthodontic wire and brackets for fixing the orthodontic wire to teeth; and
the magnetic element partly or entirely constitutes the orthodontic wire.

16. An orthodontic appliance according to claim 14, wherein:
the braces include an orthodontic wire and brackets for fixing the orthodontic wire to teeth; and
the magnetic element constitutes some or all of the brackets.

17. An orthodontic appliance according to claim 1, wherein the magnetic field generator generates a magnetic field whose direction is fixed and whose magnitude cyclically changes.

18. An orthodontic appliance according to claim 1, wherein the magnetic field generator generates a magnetic field whose direction rotates in a specific plane and whose magnitude cyclically changes.

19. An orthodontic appliance according to claim 1, wherein the magnetic field generator generates a magnetic field between 0.15 mT (inclusive) and 0.18 mT (inclusive).

20. An orthodontic method for aligning teeth, comprising:
a step of mounting braces on a specified tooth included in the teeth to align the teeth;
a step of attaching a magnetic element to the teeth; and
a step of forming a magnetic field for vibrating the magnetic element attached to the teeth and applying the vibration of the magnetic element to the tooth on which the braces are mounted.
